(19) United States
(12) Patent Application Publication
(10) Pub. No.: US 2026/0122725 A1
(43) Pub. Date: Apr. 30, 2026

(54) Wireless Device, First Network Node, and Methods Performed Thereby for Handling a Configuration

(71) Applicant: Telefonaktiebolaget LM Ericsson (publ), Stockholm (SE)

(72) Inventors: Mattias Bergström, Sollentuna (SE); Cecilia Eklöf, Täby (SE); Martin van der Zee, Malmö (SE)

(21) Appl. No.: 19/116,946

(22) PCT Filed: Sep. 27, 2023
(86) PCT No.: PCT/SE2023/050947

§ 371 Date: Mar. 28, 2025

Related U.S. Application Data
(60) Provisional application No. 63/377,540, filed on Sep. 29, 2022.

(51) Int. Cl. H04W 76/40; H04L 43/0876

(52) U.S. Cl. CPC H04W 76/40; H04L 43/0876

(57) ABSTRACT

A method, performed by a wireless device (130), for handling a configuration. The wireless device (130) operates in a wireless communications network (100). The wireless device (130) determines (302), while the wireless device (130) lacks an active connection with any network node (110) operating in the wireless communications network (100), whether or not the wireless device (130) is to perform one or more measurements for broadcast or multicast traffic. The wireless device (130) determines (303), based on a first result of the determination, whether or not to establish a connection with a first network node (111) operating in the wireless communications network (100) to receive the configuration. The configuration is to perform the one or more measurements. The wireless device (130) then establishes (304) the connection with the first network node (111) based on a second result of the determination of whether or not to establish the connection.

### TECHNICAL FIELD

The present disclosure relates generally to a wireless device and methods performed thereby for handling configuration. The present disclosure further relates generally to a network node and methods performed thereby, for handling the configuration.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Overview of the Quality of Experience (QoE) Framework

### Legacy QoE Measurements

QoE measurements, also referred to as “application layer measurements”, have been specified for LTE, Universal Mobile Terrestrial System (UMTS) and were recently specified for 5G NR in the 3GPP Rel-17. The purpose of the QoE measurements may be understood to be to measure the experience of the end user using certain applications. Currently, the QoE measurements may be understood to be specified and supported for Dynamic Adaptive Streaming over Hypertext Transfer Protocol (DASH) streaming, Mobility Telephony Service for Internet Protocol Multimedia Subsystem (MTSI) services, and Virtual Reality (VR).

The solutions in LTE and UMTS may be understood to be similar with the overall principles as follows. QoE Measurement Collection (QMC) may be understood to enable configuration of application layer measurements in the UE and transmission of QoE measurement result files, commonly referred to as “QoE reports”, to the network by means of Radio Resource Control (RRC) signalling. An application layer measurement configuration, also called QoE measurement configuration or QoE configuration, that the RAN may receive from the Operations, administration and management (OAM) system, or the Core Network (CN), may be encapsulated in a transparent container, which may be forwarded to a UE in a downlink RRCReconfiguration message. An application layer measurement report, also called QoE report, that the UE Access Stratum (UE AS) or UE RRC layer may receive from the UE's higher layer, application layer, may be encapsulated in a transparent container and sent to the network in an uplink RRC message, MeasurementAppLayerReport. The RAN may then forward the QoE report to a Measurement Collector Entity (MCE).

In 3GPP Rel-17 “Study on NR QoE management and optimizations for diverse services”, with the purpose to study solutions for QoE measurements in NR, was finalized and concluded. According to this item, QoE management in NR may not just collect the QoE parameters of streaming services but also consider the typical performance requirements of diverse services, e.g., Augmented Reality (AR)/VR and Ultra-Reliable Low-Latency Communication (URLLC), of which at least VR was covered in 3GPP Rel-17. Based on requirements of services, the NR study also included more adaptive QoE management schemes that may enable network optimization to satisfy user experience for diverse services.

The configuration data related to QoE measurements, in standard specifications typically referred to as application layer measurements, may consist of a service type indication, an indication of an area in which the measurements may have to be performed, denoted area scope, an Internet Protocol (IP) address of the entity the collected measurement results, e.g., the QoE reports, may have to be sent to, often referred to as a MCE, spelled out as Measurement Collector Entity or Measurement Collection Entity, and a set of instructions of which type of measurements that may have to be performed, and details of how these measurements may have to be performed. These instructions may be intended for the application layer in the UE and may be placed in a “container” which cannot be read and interpreted by the network entities handling it, e.g., forwarding it to the UE, as well as the UE Access Stratum. The currently specified service types are MTSI and streaming service, DASH, and in 3GPP Rel-17, VR was added. An area scope may be defined in terms of cells or network related areas. In UMTS, an area scope may be defined as either a list of cells, a list of routing areas, or a list of tracking areas. In LTE, an area scope may be defined as either a list of cells or a list of tracking areas. In NR, an area scope may be defined as either a list of cells or a list of tracking areas.

QoE, and in particular, the QoE configuration, may come in two flavors: management-based (m-based) QoE configuration and signaling-based (s-based) QoE configuration. In both cases, the QoE configuration may originate in the OAM system or some other administrational entity, e.g., dealing with customer satisfaction. All of these entities may be in this document referred to as the OAM system, where the OAM system may also contain further entities.

With the m-based QoE, the OAM system may be typically interested in general QoE statistics from a certain area, configured as an area scope. The m-based QoE configuration may be sent directly from the OAM system to the RAN nodes controlling cells that may be within the area scope. Each RAN node may then select UEs that may be within the area scope, and also fulfil any other relevant condition, such as supporting the concerned application/service type, and send the m-based QoE configuration to these UEs.

With the s-based QoE, the OAM system may be interested in collecting QoE measurement results from a specific UE, e.g., because the user of the UE may have filed a complaint. The OAM system may send the s-based QoE configuration to the Home Subscriber Server (HSS), in Evolved Packet System (EPS)/LTE, or Unified Data Management (UDM), in 5GS/NR, which may forward the QoE configuration to the current core network node (CN) of the UE, e.g., a Mobility Management Entity (MME) in EPS/LTE or an Access and Mobility management Function (AMF) in 5G/NR. The CN may then forward the s-based QoE configuration to the RAN node that may serve the concerned UE and the RAN may forward it to the UE.

Forwarded to the UE may be the service type indication and the container with the measurement instructions. The UE may not be aware of whether a received QoE configuration may be m-based or s-based. In legacy systems, the QoE framework may be integrated with the Trace functionality and a Trace Identity (ID) may be associated with each QoE configuration. In NR, the QoE functionality may be logically separated from the Trace functionality, but it may still partly reuse the Trace signaling mechanisms. In NR, and possibly in LTE, a globally unique QoE reference, formed of Mobile Country Code (MCC)+Mobile Network Code (MNC)+QoE Measurement Collection (QMC) ID, where the QMC ID may be a string of 24 bits, may be associated with each QoE configuration. The QoE reference may be included in the container with measurement instructions and also sent to the RAN, e.g, the gNB in NR. For the communication between the gNB and the UE, the QoE reference may be replaced by a shorter identifier denoted as measConfigAppLayerId, which may be understood to be locally unique within a UE, e.g., there may be a one-to-one mapping between a measConfigAppLayerId and a QoE reference for each QoE configuration provided to a UE. The measConfigAppLayerId may be stored in the UE Access Stratum and also forwarded in an ATtention command (AT Command), which may be understood to be the type of instructions used in the communication between the modem part of the UE, and the application layer of the UE, together with the service type indication and the container with the measurement instructions.

Reports with collected QoE reports may be sent from the UE application layer to the UE Access Stratum, which may forward them to the RAN, which may in turn forward them to the MCE. These QoE reports may be placed in a “container”, which may be uninterpretable for both the UE Access Stratum and the RAN. QoE reporting may be configured to be periodic or only to be sent at the end of an application session. Furthermore, the RAN may instruct the UE to pause QoE reporting, e.g., in case the cell/gNB may be in a state of overload.

The RAN may not be automatically aware of when an application session with an associated QoE measurement session may be ongoing, and the UE Access Stratum may also be not automatically aware of this. To alleviate this, session “start”/“stop” indications, which may be sent from the application layer in the UE to the UE AS and from the UE AS to the RAN, were introduced. A session “stop” indication may be explicit or may be implicit in the form of a QoE report sent when the application session and the associated QoE measurement session may have concluded.

The RAN may decide to release a QoE configuration in a UE at any time, as an implementation-based decision. Typically, it may be done when the UE may have moved outside a configured area scope.

One opportunity provided by legacy solutions may be also to be able to keep the QoE measurement for the whole session, even during a handover situation. It is also discussed to let the UE continue with the QoE measurements on an ongoing application session until the application session ends, even if the UE in the meantime may move out of the configured area scope.

### Multicast and Broadcast Service Overview

### General

Multicast and Broadcast Service (MBS) may be understood to be a point-to-multipoint service in which services and data may be transmitted from a single source entity to multiple recipients, either to all UEs in a Broadcast service area, or to users in a multicast group as defined in 3GPP TS 23.247, v. 17.4.0.

5G NR system may be understood to enable delivery of Multicast Broadcast Service (MBS) in a resource-efficient way. Via the MBS, the same service and the same specific content data from a single source may be provided simultaneously to all UEs in a geographical area, in the broadcast communication service, or to a dedicated set of UEs, in the multicast communication service. That is, all UEs in a broadcast area may receive the data, while not all UEs may be authorized to receive the data in a multicast area.

A UE may receive a broadcast MBS communication service independently of its RRC state, while a multicast MBS service may be received only by the UEs in the RRC_CONNECTED state. Multicast communication data may be delivered to a UE via Point-to-Point (PTP) and/or Point-To-Multipoint (PTM) mechanisms, and Hybrid-Automatic Retransmission request (HARQ) retransmission/feedback may be applied to both of these mechanisms, as specified in 3GPP TS 38.300, v. 16.10.0.

FIG. 1 is a schematic diagram illustrating MBS delivery methods as shown in 3GPP TS 23.247, v. 17.4.0. For a multicast communication service, shared and individual delivery modes may be specified in 3GPP TS 23.247. Between 5G Core network (5GC) and Next Generation (NG)-RAN, there may be two possible delivery methods to transmit the MBS data.

The first method may be the 5GC Individual MBS traffic delivery method. This method may only be applied for multicast MBS sessions. 5GC may receive a single copy of MBS data packets and may deliver separate copies of those MBS data packets to individual UEs via per-UE Packet Data Unit (PDU) sessions, hence for each such UE one PDU session may be required to be associated with a Multicast MBS session. The MBS data received by the MB-User Plane Function (UPF) may be replicated towards the UPF(s), where individual delivery may be performed via unicast transport over N19mb interface.

The second method may be the 5GC Shared MBS traffic delivery method. This method may be applied for both broadcast and multicast MBS sessions. 5GC may receive a single copy of MBS data packets and may deliver a single copy of those MBS packets to an NG-RAN node, which may then deliver the packets to one or multiple UEs. These incoming MBS traffic packets may be delivered from Multicast Broadcast User Place Function (MB-UPF) to NG-RAN node via the N3mb interface.

The 5GC Shared MBS traffic delivery method may be required in all MBS deployments. The 5GC Individual MBS traffic delivery method may be required to enable mobility when there may be an NG-RAN deployment with non-homogeneous support of MBS.

Between the NG-RAN and the UE, two delivery methods may be available for the transmission of MBS data packets over radio interface.

The first delivery method may be the Point-to-Point (PTP) delivery method. NG-RAN may deliver separate copies of MBS data packets over radio interface to individual UE(s).

The second delivery method may be the Point-to-Multipoint (PTM) delivery method. NG-RAN may deliver a single copy of MBS data packets over radio interface to multiple UEs.

The NG-RAN may use a combination of PTP/PTM to deliver MBS data packets to UEs.

### MBS Radio Bearer

An MBS Session Resource may be associated with one or more MBS Quality of Service (QoS) flows, and each of those flows may be associated with a QoS profile. The gNB may provide one or more multicast MBS Radio Bearer (MRB) configurations to the UE via RRC signalling, as described in TS 38.300, v. 16.10.0, clause 16.10.3. For a multicast session, the gNB may change the MRB type using RRC signalling. For a broadcast session, the gNB may provide a broadcast MRB with one Downlink (DL)-only Radio Link Control (RLC)-Unacknowledge Mode (UM) entity for PTM transmission, that is, only one type of an MRB may be specified at the moment for the broadcast communication transmission. Network and protocol architectures are described in detail in 3GPP TS 38.300, v. 16.10.0 chapters 16.10.2 and 16.10.3.

### Group Scheduling and Group Paging

Group scheduling mechanisms for MBS delivery are described in 3GPP TS 38.300, v. 16.10.0, clause 16.10.4. Radio Network Temporary Identifier (RNTI) may be used for the group transmission where a UE may receive different services using the same or different Group-RNTI(s) (G-RNTI(s))/Group Configured Scheduling RNTI(s) (G-CS-RNTIs), as defined in 3GPP TS 38.300, v. 16.10.0. NG-RAN may perform certain functions to support MBS. They may include management of MBS QoS flows, delivery of MBS data packets from 5GC to multiple UEs via PTP or PTM, configuration of UE for MBS QoS flow reception at Access Stratum (AS) layer, controlling switching between PTM and PTP delivery per UE, support for multicast session service continuity during Xn and NG handovers, and support for group paging at multicast session activation over radio toward UEs in CM-IDLE state and CM-CONNECTED with RRC INACTIVE state.

### MBS Interest Indication

To ensure service continuity of MBS broadcast, the UE in RRC_CONNECTED state may send MBS Interest Indication to the gNB, consisting of the following information. One type of information may be a list of MBS frequencies UE may be interested in receiving, sorted in decreasing order of interest. Another type of information may be a priority between the reception of all listed MBS frequencies and the reception of any unicast bearer. A further type of information may be a list of MBS broadcast services the UE may be interested in receiving, in case System Information Block (SIB) 20 (SIB20) may be scheduled by the Primary Cell (PCell) of the UE. Yet another type of information may be a UE's priority to MBS broadcast versus unicast reception.

MBS Interest Indication information reporting may be implicitly enabled/disabled by the presence of SIB21.

### Mobility Support During MBS Session

Mobility support for service continuation when a UE may be in an MBS session may depend on whether the broadcast or multicast session may be taking place, and on whether the source and target nodes may support MBS. For the multicast MBS session, three cases may be distinguished: 1) handover from an NG-RAN node supporting MBS to a node not supporting MBS, 2) handover from an NG-RAN node not supporting MBS to a node supporting MBS, and 3) a handover from a node supporting MBS to another node supporting MBS.

In the Multicast MBS case, when the Handover (HO) may take place from a node that may support MBS to a node that may not support MBS, or vice versa, the 5GC Shared MBS Traffic Delivery and 5GC Individual Traffic delivery methods may co-exist temporarily upon handover. Mapping information about unicast QoS flows for multicast data transmission and the information of associated multicast QoS flows may be provided to an NG-RAN node. The delivery method may be switched from 5GC Shared MBS Traffic delivery to 5GC Individual MBS delivery via establishing the N3 tunnel of the PDU Session for Individual delivery. The Session Management Function (SMF) may realize that the target node may not support MBS. The General Packet Radio Service Tunnelling Protocol (GTP) tunnel between the UPF and the Multicast Broadcast User Place Function (MB-UPF) for 5GC Individual MBS traffic delivery activated by SMF and Multicast Broadcast Session Management Function (MB-SMF). When the HO takes place from a RAN node that may support MBS to another node that may also support MBS, if the shared delivery for the MBS session has not been established towards the target NG-RAN node, it may use MB-SMF and MB-UPF to establish the Shared delivery for the MBS session. The PDU Sessions, including the one associated with the MBS Multicast session and used for the 5GC Individual MBS traffic delivery, may be handed over to the target NG-RAN node. The SMF may trigger the mode switch from the Individual to the Shared delivery mode. The Target node may establish the shared delivery for the MBS Session upon receiving the MBS Session Context. The 5GC Individual MBS traffic delivery may be terminated by 5GC and changed to the 5GC shared MBS traffic delivery.

In the Broadcast MBS case, the UE may receive the same service in the target node, which may support MBS, if the same MBS session may be established with the 5GC Shared MBS traffic delivery. Currently, a case of when a UE may be handed over to a node not supporting the MBS within the broadcast area, is not specified.

### QoE and RAN-Visible QoE (RVQoE) Metrics for MBMS

The 3GPP TS 26.346, v. 16.10.0 defines QoE metrics for the Multimedia Broadcast Multicast Service (MBMS), in addition to QoE metrics for DASH streaming that may also be used. The full table from TS 26.346 is presented below for reference as Table 1.

According to current 3GPP TS 38.423 v. 17.0.0, clause 9.2.3.158, the available RAN visible QoE metrics are Buffer Level and Playout Delay for Media Startup which may be available for DASH streaming and VR service types.

TABLE 1

| | Streaming | Download | |
|---|---|---|---|
| | delivery | delivery | Metric |
| QoE Metric | method | method | type |
| Corruption duration metric | ✓ | | Media |
| Rebuffering duration metric | ✓ | | Session |
| Initial buffering duration metric | ✓ | | Session |
| Successive loss of RTP packets | ✓ | | Media |
| Frame rate deviation | ✓ | | Media |
| Jitter duration | ✓ | | Media |
| Content Access/Switch Time | ✓ | | Session |
| Network Resource | ✓ | ✓ | Session |
| Average codec bitrate | ✓ | | Media |
| Codec information | ✓ | | Media |
| Loss of Objects | | ✓ | Session |
| Distribution of Symbol Count Underrun | | ✓ | Session |
| for Failed Blocks | | | |

RVQoE metrics for at Application Layer:

As one option, or for some RVQoE metrics, the UE AS may forward RVQoE metrics received from the UE Application Layer to the RAN without modification or additions.

One or more (raw) QoE metrics may be measured at UE Application Layer, and subsequently the following may apply. In a first aspect, the QoE metrics may be sent from the Application Layer of the UE to the UE Access Stratum, in a format, e.g., RRC format, that the UE AS may easily include in, or convert into, a field in an RRC message. The information obtained from the raw QoE metrics and included in the RRC message may constitute the RAN Visible QoE metrics. In a second aspect, the RAN Visible QoE metrics may then be sent from the UE RRC layer to RAN, without modification at UE Access Stratum.

### RVQoE Metrics at Access Stratum Layer:

As another option, or for some RVQoE metrics, the UE AS may modify or add to the RVQoE metrics received from the UE Application Layer before forwarding them to the RAN

One or more (raw) QoE metrics may be measured at the UE Application Layer, and subsequently, the following may apply. In a first aspect, the QoE metrics may be sent from the Application Layer of the UE to the UE Access Stratum, in a format, e.g., RRC format, that the UE AS may easily include in, or convert into, a field in an RRC message. The information obtained from the raw QoE metrics and, via the described steps, included in the RRC message may constitute the RAN Visible QoE metrics. In a second aspect, before sending the RAN Visible QoE metric to the RAN, the RAN Visible QoE metrics as received from the Application Layer, may be modified by the UE Access Stratum. In a third aspect, the obtained version of the RAN Visible QoE metrics may then be sent from the UE RRC layer to RAN.

### RVQoE Values, or RVQoE Scores, at Application Layer:

RAN-visible QoE values may be understood as a set of values derived from raw QoE metrics through a model/function.

One or more representations, e.g., mapping, of (raw) QoE metrics may be measured at UE Application Layer, and subsequently the following may apply. In a first aspect, the representations may be sent from the Application Layer of the UE to the UE Access Stratum, e.g., in RRC format, e.g., in a format that the UE AS may easily include in, or convert into, a field in an RRC message. In a second aspect, the representations may then be sent from the UE RRC layer to RAN without modification at UE Access Stratum.

### RVQoE Values, or RVQoE Scores, at Access Stratum:

One or more representations, e.g., mapping, of, e.g., raw, QoE metrics may be measured at UE Application Layer, and subsequently the following may apply. In a first aspect, the representations may be sent from the Application Layer of the UE to the UE Access Stratum in RRC format, e.g., in a format that the UE AS may easily include in, or convert into, a field in an RRC message. In a second aspect, the representations may then be modified by the UE Access Stratum. In a third aspect, the modified version of the representations may then be sent from the UE RRC layer to the RAN.

### 3GPP Rel-18 QoE Work Item

For 3GPP Rel-18, the RP-221803 describes the Work Item “Enhancement on NR QoE management and optimizations for diverse services” and among others, it indicates the following objectives. As a first objective, support for new service type, such as AR, Mixed Reality (MR), MBS and other new service type defined or to be supported by SA4. Also, support RAN-visible parameters for the additional service types, and the existing service if needed, and the coordination with SA4 may be needed [RAN3, RAN2]. A particular objective may be to specify the new service and the existing service defined or to be supported by SA4, combined with high mobility scenarios, e.g., High Speed Trains. As a second objective, specify for QoE measurement configuration and collection in RRC_INACTIVE and RRC_IDLE states for MBS, at least for broadcast service [RAN3, RAN2]. A particular objective may be to specify the mechanism to support the alignment of the existing radio related measurement and QoE reporting. As a third objective, left-over features from Rel-17, as well as the enhancements of existing features which are not included in Rel-17 normative phase, may have to be supported in Rel-18 if consensus on benefits are reached [RAN3, RAN2]. A first particular objective may be to specify per-slice QoE measurement configuration enhancement. A second particular objective may be to specify RAN visible QoE enhancements for QoE value, RAN visible QoE trigger event, and RAN visible QoE Report over F1. A third particular objective may be to specify QoE reporting handling enhancement for an overload scenario.

According to existing methods, wireless devices may under some circumstances be unable to perform measurements, such as QoE measurements, which may result in poor user experience.

### SUMMARY

As part of the development of embodiments herein, one or more challenges with the existing technology will first be identified and discussed.

In existing specifications, a UE may only be configured with QoE measurements while in RRC_CONNECTED. However, a UE may be in RRC_IDLE or RRC_INACTIVE when the UE receives broadcast or multicast traffic. Since the UE does not have any connection with the network, the UE cannot acquire a QoE configuration to receive the configuration and hence the UE cannot perform the QoE measurements.

Certain aspects of the present disclosure and their embodiments may provide solutions to these or other challenges.

According to the foregoing, it is an object of embodiments herein to improve the handling of a configuration.

According to a first aspect of embodiments herein, the object is achieved by a method, performed by a wireless device. The method is handling a configuration. The wireless device operates in a wireless communications network. The wireless device determines, while the wireless device lacks an active connection with any network node operating in the wireless communications network, whether or not the wireless device is to perform one or more measurements for broadcast or multicast traffic. The wireless device also determines, based on a first result of the determination, whether or not to establish the connection with the first network node operating in the wireless communications network to receive the configuration. The configuration is to perform the one or more measurements. The wireless device then establishes the connection with the first network node based on a second result of the determination of whether or not to establish the connection

According to a second aspect of embodiments herein, the object is achieved by a method, performed by the first network node. The method is for handling the configuration of the wireless device. The first network node operates in the wireless communications network. The first network node determines, while the first network node lacks an active connection with the wireless device operating in the wireless communications network, whether or not the wireless device is to perform the one or more measurements for broadcast or multicast traffic. The first network node sends, based on a result of the determination, a first indication to the wireless device. The first indication indicates whether or not the wireless device is to perform the one or more measurements. The first network node establishes the connection with the wireless device based on the result of the determination and after having sent the first indication. With the proviso the first network node establishes the connection, the first network node is enabled to provide the configuration to perform the one or more measurements.

According to a third aspect of embodiments herein, the object is achieved by the wireless device, configured to perform the method. The wireless device may be understood to be for handling the configuration. The wireless device is configured to operate in the wireless communications network. The wireless device is configured to determine, while the wireless device lacks an active connection with any network node configured to operate in the wireless communications network, whether or not the wireless device is to perform one or more measurements for broadcast or multicast traffic. The wireless device is also configured to determine, based on the first result of the determination, whether or not to establish the connection with the first network node configured to operate in the wireless communications network to receive the configuration. The configuration is configured to be to perform the one or more measurements. The wireless device is further configured to establish the connection with the first network node based on the second result of the determination of whether or not to establish the connection.

According to a fourth aspect of embodiments herein, the object is achieved by the network node, configured to perform the method. The network node may be understood to be for handling the configuration of the wireless device. The network node is configured to operate in the wireless communications network. The network node is configured to determine, while the first network node lacks an active connection with the wireless device 130 configured to operate in the wireless communications network, whether or not the wireless device is to perform one or more measurements for broadcast or multicast traffic. The first network node is also configured to send, based on a result of the determination, the first indication to the wireless device. The first indication is configured to indicate whether or not the wireless device is to perform the one or more measurements. The first network node is further configured to establish the connection with the wireless device based on the result of the determination, and after having sent the first indication. Additionally, with the proviso the first network node establishes the connection, the first network node is configured to be enabled to provide the configuration to perform the one or more measurements.

By the wireless device determining, while lacking an active connection with any network node, whether or not the wireless device is to perform the one or more measurements, then determining whether or not to establish the connection with the first network node, based on a first result of the determination, and then establishing the connection based on the second result of the second determination, the wireless device may enable that the configuration to perform the one or more measurements may be provided to the wireless device directly when it may be needed, even when the wireless device may be in idle or inactive state. That may be understood to mean that the wireless device may then be enabled to start performing the measurements at the desired time. Hence, more measurements may be collected, and the first network node may ultimately be enabled to perform better analysis of the end users experience and take relevant actions.

Moreover, the wireless device may advantageously be enabled to make use of its resources more effectively. This may be understood to be because whenever the wireless device may not need to perform the one or more measurements, the wireless device may avoid wasting processing power to measure, and to send the measuring reports, which may be a waste of resources if the first network node anyway does may not require that the wireless device measures a certain traffic.

Furthermore, the wireless device may enable to refrain from performing unnecessary connections to the first network node, e.g., whenever the wireless device may not be going to receive the traffic anyway. The wireless device 130 therefore be enabled to make use of its resources, and those of the first network node more effectively.

### BRIEF DESCRIPTION OF THE DRAWINGS

Examples of embodiments herein are described in more detail with reference to the accompanying drawings, according to the following description.

FIG. 1 is a schematic diagram illustrating MBS delivery methods as shown in 3GPP TS 23.247, v. 17.3.0.

FIG. 2 is a schematic diagram depicting an example of a wireless communications network, according to embodiments herein.

FIG. 3 is a flowchart depicting a method in a wireless device, according to embodiments herein.

FIG. 4 is a flowchart depicting a method in a first network node, according to embodiments herein.

FIG. 5 is a schematic block diagram illustrating a wireless device, according to embodiments herein.

FIG. 6 is a schematic block diagram illustrating a first network node, according to embodiments herein.

FIG. 7 is a flowchart depicting a method in a wireless device, according to embodiments herein.

FIG. 8 is a flowchart depicting a method in a first network node, according to embodiments herein.

FIG. 9 is a schematic block diagram illustrating an example of a communication system 900 in accordance with some embodiments.

FIG. 10 is a schematic block diagram illustrating a host 1000, which may be an embodiment of the host 916 of FIG. 9, in accordance with various aspects described herein.

FIG. 11 shows a communication diagram of a host 1102 communicating via a network node 1104 with a UE 1106 over a partially wireless connection in accordance with some embodiments.

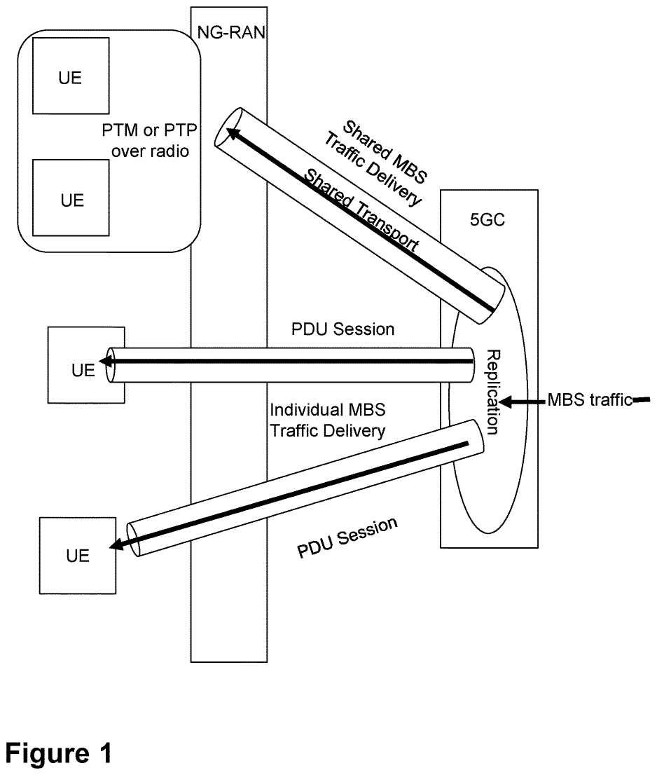

### DETAILED DESCRIPTION

Certain aspects of the present disclosure and their embodiments may provide solutions to these or other challenges. Embodiments herein may be generally understood to relate to provisioning of QoE configurations to UEs in IDLE-INACTIVE, that is in idle or inactive state or mode. Embodiments herein may be understood to enable that a UE which may be interested in receiving a broadcast or multicast traffic while being in IDLE or INACTIVE may determine if it may have to perform QoE measurements for this traffic. If so, the UE may enter CONNECTED mode to acquire a QoE configuration. In another embodiment the UE may acquire the QoE configuration from a broadcast channel such as Multicast broadcast Control Channel (MCCH) or Multicast broadcast Transmission Channel (MTCH).

The network may indicate, e.g., via broadcast signalling, if QoE measurements may have to be performed for broadcast or multicast traffic. In some embodiments, this indication may be indicated per traffic, meaning that the network may indicate that for a first traffic, QoE measurements may have to be performed, and hence the UE may need to enter RRC_CONNECTED to acquire the configuration, while for a second traffic, QoE measurements may have to not be performed.

Further details are provided where UE capabilities may be considered in the decision. And details of when the UE may enter RRC_CONNECTED. And details about what the UE may do if the traffic that the UE may be interested in has already started when the UE may have determined that it may be interested in receiving it.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

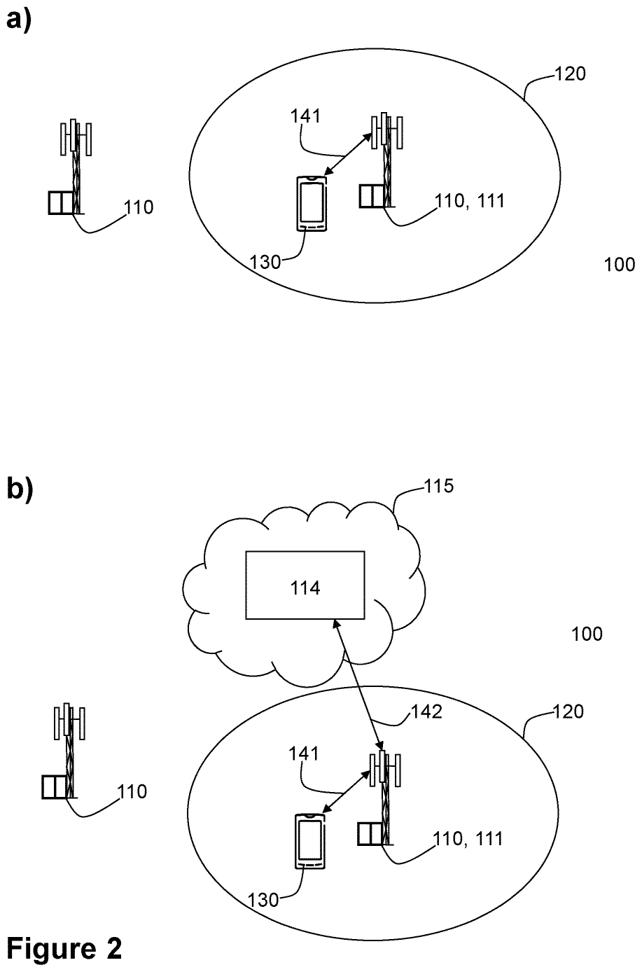

FIG. 2 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network, or a newer system with similar functionality. In other examples, the wireless communications network 100 may support other technologies such as, for example, Long-Term Evolution (LTE), e.g., LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. The wireless communications network 100 may support Machine Type Communication (MTC), enhanced MTC (eMTC), Internet of Things (IoT) and/or NarrowBand IoT (NB-IoT). Yet in other examples, the wireless communications network 100 may, in addition, further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes. Any network node 110 of the plurality of network nodes, such as a first network node 111 depicted in FIG. 2, may be a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 2 b, the network node 110 may be a distributed node, and may partially perform its functions in collaboration with a virtual network node 114 in a cloud 115. In the non-limiting examples of FIG. 2, only two network nodes 110 are depicted, the first network node 111 and another node, but this may be understood to be for illustration purposes only. There may be additional network nodes comprised in the wireless communications network 100.

The wireless communications network 100 may cover a geographical area, which in some embodiments may be divided into cell areas, wherein each cell area may be served by a radio network node, although, one radio network node may serve one or several cells. In the example of FIG. 2, only a cell 120 served by the first network node 111 is depicted. Any network node 110 operating in the wireless communications network 100, e.g., the first network node 111, may be of different classes, such as, e.g., macro base station, home base station or pico base station, based on transmission power and thereby also cell size. In some examples, any network node 110 operating in the wireless communications network 100, e.g., the first network node 111, may serve receiving nodes with serving beams. Any network node 110 operating in the wireless communications network 100, e.g., the first network node 111, may support one or several communication technologies, and its name may depend on the technology and terminology used. Any network node 110 operating in the wireless communications network 100, e.g., the first network node 111, may be directly connected to one or more core networks, e.g., to one or more network nodes in the one or more core networks.

A plurality of wireless devices may be located in the wireless communication network 100, whereof a wireless device 130, is depicted in the non-limiting example of FIG. 2. The wireless device 130 comprised in the wireless communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. The wireless device 130 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the first network node 111 over a first link 141, e.g., a radio link. The first network node 111 may be configured to communicate within the wireless communications network 100 with the virtual network node 114 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second” and/or “third” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a first network node, such as the first network node 111, e.g., a gNB.

Some embodiments herein will now be further described with some non-limiting examples.

In the following description, any reference to a/the UE, or simply “UE” may be understood to equally refer the wireless device 130; any reference to a/the gNB, a/the last serving gNB, a/the anchor gNB, a/the paging gNB and/or a/the network and/or the network node may be understood to equally refer to the first network node 111; any reference to a/the indication may be understood to equally refer to the first indication.

In this disclosure, a description is provided on how a UE may receive configurations to perform QoE measurements. However, the methods described herein may be understood to be able to be applied to other configurations for other types of measurements, that is, other than QoE measurements.

Also, it may be noted that in some cases it may be used as an example scenario that the UE may perform reception of a broadcasted traffic. However, the methods described herein may also be applied to UEs who may perform reception of a multicast traffic.

The term “traffic” is used herein to refer to something, e.g., one or more communications, that the UE may receive. Traffic may be a service, a session, a group or services, group of sessions, etc.

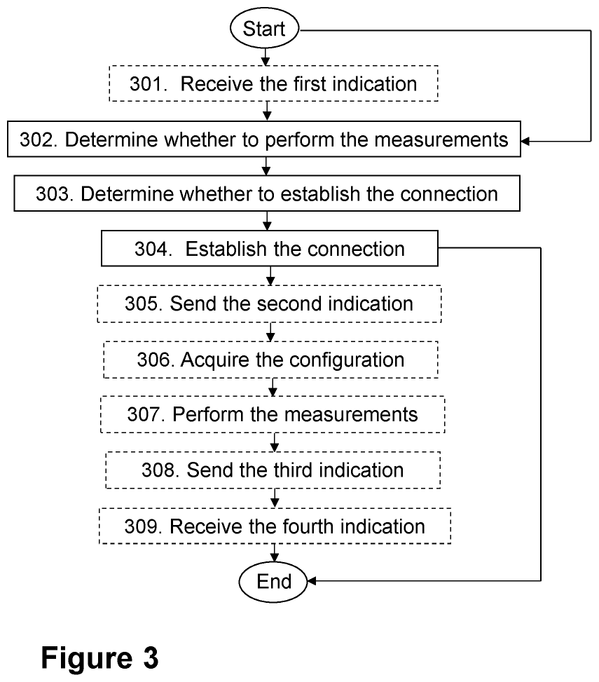

Embodiments of a method, performed by the wireless device 130, will now be described with reference to the flowchart depicted in FIG. 3. The method may be understood to be for handling a configuration. The wireless device 130 operates in the wireless communications network 100. The method may be understood to be computer-implemented.

In some embodiments, the wireless communications network 100 may support New Radio (NR).

The method may comprise one or more of the following actions. In some embodiments, all the actions may be performed. In other embodiments, some of the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 3. In FIG. 3, optional actions in some embodiments may be represented with dashed lines. In some embodiments, the actions may be performed in a different order than that depicted FIG. 3.

### Action 301

In this Action 301, the wireless device 130 may receive a first indication.

The receiving in this Action 301 may be from the first network node 111.

The first indication may indicate whether or not the wireless device 130 may have to perform one or more measurements.

The one or more measurements may be quality of experience measurements. That is, the first indication may be understood to be a network indication of whether the UE may have to measure QoE.

The receiving in this Action 301 may be performed, e.g., via the first link 141.

In some embodiments, the first indication may further indicate whether or not the wireless device 130 may have to perform the one or more measurements, per type of traffic. That is, the first indication may be indicated per type of traffic. For example, the first network node 111 may provide two broadcasted traffics, traffic X and traffic Y. The first network node 111 may only be interested in QoE measurements for traffic X, but not for traffic Y. The first network node 111 may then indicate that the wireless device 130 may have to perform QoE measurements for traffic X.

These indications, that is, the first indication, may only be considered by UEs in IDLE or INACTIVE. A UE such as e.g., the wireless device 130, which may be in CONNECTED mode, may ignore these indications. The motivation for this is that the first network node 111 may have dedicated control of UEs in CONNECTED mode and hence the first network node 111 may decide on a per-UE basis whether the UEs may have to perform QoE measurements, and only send the corresponding configuration to those UEs. While for UEs in IDLE and INACTIVE mode, the first network node 111 may not have dedicated control and hence this per-traffic indication may allow the network to ensure that the UEs may be only performing QoE measurements for relevant traffic, while for other traffic the UEs may not need to spend processing power to measure, and they may also not have to send the report, which may be a waste of resources if the first network node 111 anyway does not require that the wireless device 130 measures a certain traffic.

The first indication may be further detailed to indicate a limited group of UE's e.g., an indication per type of traffic.

In some embodiments, the first indication may be received in a broadcast message. That is, the first network node 111 may indicate to the wireless device 130 whether QoE measurements may have to be performed by the wireless device 130. This may be indicated to the wireless device 130 using a broadcasted message.

In some embodiments, the first indication may explicitly indicate the configuration may have to be fetched for a broadcast reception.

### Action 302

In this Action 302, the wireless device 130 determines, while the wireless device 130 lacks an active connection with any network node 110 operating in the wireless communications network 100, whether or not the wireless device 130 is to perform one or more measurements for broadcast or multicast traffic.

The wireless device 130 lacking the active connection with any network node 110 may be in one of IDLE and INACTIVE mode.

Determining in this Action 302 may comprise deciding or calculating.

The determining in this Action 302 of whether or not the wireless device 130 may have to perform the one or more measurements may be based on the received first indication.

In some embodiments, the determining in this Action 302 of whether or not the wireless device 130 is to perform the one or more measurements may be responsive to the wireless device 130 having determined, while the wireless device 130 may lack the active connection with any network node 110, that the wireless device 130 may desire to receive at least one of broadcast and multicast traffic.

By the wireless device 130 determining in this Action 302, while lacking an active connection with any network node 110, whether or not the wireless device 130 is to perform the one or more measurements, the wireless device 130 may enable that the configuration to perform the one or more measurements may be provided to the wireless device 130 directly when it may be needed, even when the wireless device 130 may be in idle or inactive state. That may be understood to mean that the wireless device 130 may then be enabled to start performing the measurements at the desired time. Hence, more measurements may be collected, and the first network node 111 may ultimately be enabled to perform better analysis of the end users experience and take relevant actions.

Moreover, the wireless device 130 may advantageously be enabled to make use of its resources more effectively. This may be understood to be because whenever the wireless device 130 may not need to perform the one or more measurements, the wireless device 130 may avoid wasting processing power to measure, and to send the measuring reports, which may be a waste of resources if the first network node 111 anyway does may not require that the wireless device 130 measures a certain traffic.

### Action 303

In this Action 303, the wireless device 130 determines, based on a first result of the determination in Action 302, whether or not to establish the connection with the first network node 111 operating in the wireless communications network 100 to receive the configuration. The configuration is to perform the one or more measurements. For example, as part of this Action 303, the wireless device 130 may determine a time of entering CONNECTED mode.

Determining in this Action 303 may comprise deciding or calculating.

In some embodiments, the determining in this Action 303 of whether or not to establish the connection with the first network node 111 may be based on at least one of the following options.

According to a first option, the determining in this Action 303 of whether or not to establish the connection with the first network node 111 may be based on whether or not the wireless device 130 may intend to receive the broadcast or multicast traffic. For example, the wireless device 130 may enter CONNECTED mode in response to determining that the first network node 111 has advertised that a traffic may be provided from the first network node 111 and the wireless device 130 may be interested in receiving that traffic. For example, the wireless device 130 may be capable of receiving a traffic, and the first network node 111 may have indicated that the wireless device 130 may have to perform QoE measurements for that traffic. However, if the wireless device 130 is not intending to receive that traffic, the wireless device 130 may refrain from entering CONNECTED mode to receive the measurement configuration. This may be understood to have the benefit that unnecessary connections to the network may not be performed by UEs which may not be going to receive the traffic.

According to a second option, the determining in this Action 303 of whether or not to establish the connection with the first network node 111 may be based on whether or not the wireless device 130 may determine that the broadcast or multicast traffic has already started. For example, the wireless device 130 may only connect to the first network node 111 if the wireless device 130 is going to receive the traffic from the start. If the wireless device 130 determines that the traffic has already started at the time when the wireless device 130 determines that the wireless device 130 is interested in a traffic, the wireless device 130 may not be able to receive the traffic from the start. In this case, the wireless device 130 may refrain from connecting to the network to get the QoE measurement configuration for performing the measurements of it. This may be understood to have the benefit that it may be of less interest to the first network node 111, or network operator, to receive QoE measurements if the wireless device 130 is not able to perform the measurements for the whole traffic duration.

According to the third and fourth option, the wireless device 130 may consider UE capabilities.

According to a third option, the determining in this Action 303 of whether or not to establish the connection with the first network node 111 may be based on whether or not the wireless device 130 may have a first capability to receive broadcast receptions.

According to a fourth option, the determining in this Action 303 of whether or not to establish the connection with the first network node 111 may be based on whether or not the wireless device 130 may have a second capability to perform the one or more measurements. The wireless device 130 may only enter CONNECTED mode to receive the QoE configuration if the wireless device 130 is capable of performing QoE measurements. To perform QoE measurements may be understood to be an optional feature for the wireless device 130 to support. If the wireless device 130 is not capable of performing QoE measurements, even if the wireless device 130 may be capable of receiving the broadcast reception, the wireless device 130 may refrain from connecting to the first network node 111.

For example, the first network node 111 may explicitly indicate to the wireless device 130 whether QoE configurations may need to be fetched for a broadcast reception. If the wireless device 130 sees the first indication and supports QoE, it may establish a connection to the first network node 111 and receive the QoE configuration. The first indication may be further detailed to indicate a limited group of UE's e.g., an indication per type of traffic.

The wireless device 130 may also consider the capability of the wireless device 130 of receiving a broadcast reception. If the wireless device 130 is capable of performing QoE measurements, but the wireless device 130 is not capable of receiving broadcast receptions, or in a special case: the wireless device 130 is capable of receiving broadcast, but the wireless device 130 may not be able to receive a particular broadcast reception, e.g., due to not having credentials to do so, which may be the case if a traffic is only intended for a certain group or UEs, the wireless device 130 may refrain from entering connected to receive the QoE configuration.

In some embodiments, the determining in Action 302 of whether or not the wireless device 130 is to perform the one or more measurements may be responsive to the wireless device 130 having determined, while the wireless device 130 may lack the active connection with any network node 110, that the wireless device 130 may desire to receive at least one of broadcast and multicast traffic.

In some of these embodiments, the determining in Action 303 of whether or not to establish the connection with the first network node 111 may further comprise determining whether or not the wireless device 130 may have a valid configuration to perform the one or more measurements. In one example, the wireless device 130 may be in IDLE or INACTIVE may, and upon determining that the wireless device 130 may need to perform measurements for a broadcast reception in Action 302, the wireless device 130 may determine if the wireless device 130 may have a valid QoE measurement configuration for this traffic. If the wireless device 130 does not have such a configuration, the wireless device 130 UE may determine in this Action 303 to establish a connection to the first network node 111, e.g., enter CONNECTED mode.

By the wireless device 130 determining, based on a first result of the determination in Action 302, whether or not to establish the connection with the first network node 111 in this Action 303, e.g., the wireless device 130 may enable that the configuration to perform the one or more measurements may be provided to the wireless device 130 directly when it may be needed, even when the wireless device 130 may be in idle or inactive state. That may be understood to mean that the wireless device 130 may then be enabled to start performing the measurements at the desired time. Hence, more measurements may be collected, and the first network node 111 may ultimately be enabled to perform better analysis of the end users experience and take relevant actions.

Furthermore, the wireless device 130 may enable to refrain from performing unnecessary connections to the first network node 111, e.g., whenever the wireless device 130 may not be going to receive the traffic anyway. The wireless device 130 may therefore be enabled to make use of its resources, and those of the first network node 111 more effectively. This may be understood to be because whenever the wireless device 130 may not need to perform the one or more measurements, the wireless device 130 may avoid wasting processing power to establish the connection with the first network node 111.

### Action 304

In this Action 304, the wireless device 130 establishes the connection with the first network node 111 based on a second result of the determination of whether or not to establish the connection in Action 303. For example, in this Action 304, the wireless device 130 may enter CONNECTED mode to acquire the QoE configuration. This may happen when the wireless device 130 may be in IDLE or INACTIVE mode and may intend to receive a certain broadcast reception. And when doing so, the wireless device 130 may be intended to measure QoE measurements for this reception.

In some embodiments, that the establishing in this Action 304 may be based on the second result may comprise refraining from establishing the connection with the proviso that at least one of the following options.

According to a first option, that the establishing in this Action 304 may be based on the second result may comprise refraining from establishing the connection with the proviso that the wireless device 130 may not be intending to receive the broadcast or multicast traffic.

According to a second option, that the establishing in this Action 304 may be based on the second result may comprise refraining from establishing the connection with the proviso that the wireless device 130 may determine that the broadcast or multicast traffic has already started.

According to a third option, that the establishing in this Action 304 may be based on the second result may comprise refraining from establishing the connection with the proviso that the wireless device 130 may lack the first capability to receive broadcast receptions.

According to a fourth option, that the establishing in this Action 304 may be based on the second result may comprise refraining from establishing the connection with the proviso that the wireless device 130 may lack the second capability to perform the one or more measurements.

In some of embodiments, the establishing in this Action 304 may be performed with the proviso that the wireless device 130 may have determined the wireless device 130 may lack the valid configuration. If the wireless device 130 does not have such a configuration, the wireless device 130 UE may establish a connection to the first network node 111, e.g., enter CONNECTED mode.

In some embodiments, the establishing in this Action 304 may be performed with the proviso that the wireless device 130 may have a first capability to receive broadcast reception.

In some embodiments, the establishing in this Action 304 may be performed with the proviso the wireless device 130 may have a second capability to perform the one or more measurements.

By, in this Action 304, establishing the connection with the first network node 111 based on the second result of the determination of whether or not to establish the connection, the wireless device 130 may enable to achieve the advantages already described in the previous Action 303.

### Action 305

In this Action 305, the wireless device 130 may send a second indication to the first network node 111.

The sending in this Action 305 may be, e.g., transmitting, and may be performed, e.g., via the first link 141.

The second indication may indicate that the configuration is requested.

In some embodiments, the second indication may indicate, explicitly or implicitly, which type of broadcast or multicast traffic the one or more measurements may have to be performed on.

In this Action 305, When the wireless device 130 may enter CONNECTED mode, the wireless device 130 may indicate to the first network node 111 that the wireless device 130 may need to receive a QoE measurement configuration. The wireless device 130 may indicate which particular traffic the wireless device 130 may need to measure. The second indication may be implicit in the sense that the wireless device 130 may only indicate that the wireless device 130 is interested in receiving a certain traffic. The first network node 111 may from this, and by inspecting the UE capabilities to ensure that the wireless device 130 is capable of QoE measurements, decide that the wireless device 130 may have to be provided with a QoE measurement report.

By sending the second indication to the first network node 111 in this Action 304, the wireless device 130 may enable to achieve the advantages already described in the previous Action 303.

### Action 306

In this Action 306, the wireless device 130 may acquire the configuration.

The acquiring in this Action 306 may be from the first network node 111 after establishing the connection.

In some embodiments, the acquiring in this Action 306 of the configuration may be in one of: a broadcast channel, a dedicated channel and a unicast channel.

In some examples, the wireless device 130 may acquire the QoE configuration from a broadcast channel. In one example, the wireless device 130 may acquire the QoE measurement configuration from the first network node 111 via a broadcast channel.

In some embodiments, the acquiring in this Action 306 of the configuration may be in one of: the broadcast channel, the dedicated channel and the unicast channel, based on a state of the wireless device 130.

In some embodiments, the broadcast channel may be one of Multicast Broadcast Control Channel (MCCH), and Multicast Broadcast Transmission Channel (MTCH).

In one version of this example, wireless device 130 may only acquire, or apply, the QoE configuration via the broadcast channel if the wireless device 130 is in a certain state, e.g., only in IDLE or INACTIVE, but if the wireless device 130 is in another state, e.g., CONNECTED, the wireless device 130 may not acquire, or apply, the QoE configuration in the broadcast channel. Instead, the wireless device 130 in CONNECTED may rely on dedicated or unicast channels to acquire the QoE configuration. The first network node 111 may, for those UEs, that is, the UEs in CONNECTED mode, determine if/which UEs may have to apply a QoE configuration and send the configuration to, e.g., only, those UEs.

In some embodiments, the acquiring in this Action 306 of the configuration may be in dedicated Radio Resource Control (RRC) signalling. The first network node 111 may, when the wireless device 130 may enter CONNECTED mode, provide the QoE measurement configuration to the wireless device 130 in dedicated RRC signalling, such as e.g., an RRCReconfiguration message.

### Action 307

In this Action 307, the wireless device 130 may perform the one or more measurements according to the configuration.

### Action 308

In this Action 308, the wireless device 130 may send a third indication.

The sending in this Action 308 may be to the first network node 111.

The third indication may indicate the performed one or more measurements according to the configuration.

### Action 309

In this Action 309, the wireless device 130 may receive a fourth indication.

The receiving in this Action 309 may be from the first network node 111, e.g., via the first link 141.

The receiving in this Action 309 may be after having performed the one or more measurements according to the configuration.

The fourth indication may indicate, e.g., whether or not the wireless device 130 may have to return to a mode wherein the wireless device 130 may lack a connection with any network node 110 operating in the wireless communications network 100.

The fourth indication may indicate the wireless device 130 may have to return to one of IDLE and INACTIVE state.

In other words, after the wireless device 130 may have received the configuration, the first network node 111 may decide to move the wireless device 130, back, to an IDLE or INACTIVE mode. The wireless device 130 may then receive the traffic and perform measurements using the configuration that the wireless device 130 received in CONNECTED mode. It may be noted that, while the first network node 111 may move the wireless device 130 to the IDLE or INACTIVE mode where the wireless device 130 may receive the traffic, the first network node 111 may keep the wireless device 130 in CONNECTED mode if there is some other reason for doing so, e.g., that the wireless device 130 may need to send or receive some data which may be more suitable, or only possible, in CONNECTED mode.

By receiving the fourth indication to the network node 110 in this Action 309, the wireless device 130 may be enabled to preserve its resources, e.g., radio, processing and energy resources, while still being enabled to receive the configuration to perform the one or more measurements directly when it may be needed, even when the wireless device 130 may be in idle or inactive state. This may be understood to be since in IDLE or INACTIVE mode, the wireless device 130 may process less information, send or receive less information and spend less energy, than in CONNECTED state.

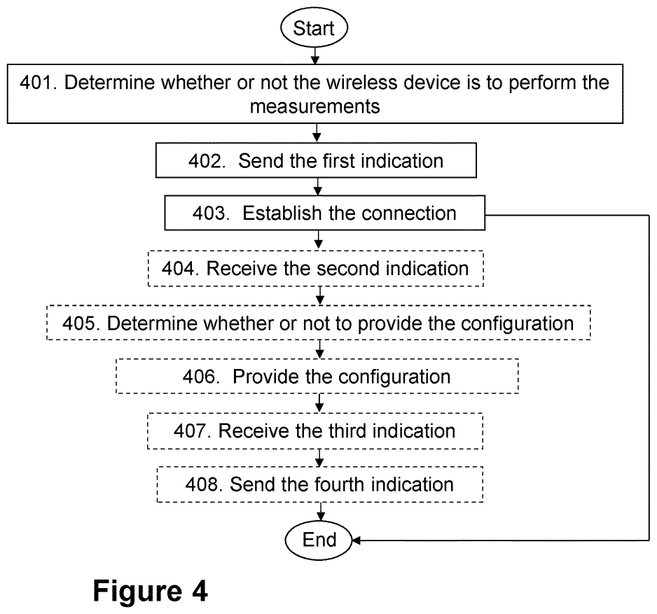

Embodiments of a method, performed by the first network node 111 will now be described with reference to the flowchart depicted in FIG. 4. The method may be understood to be for handling the configuration of the wireless device 130. The first network node 111 operates in the wireless communications network 100. The method may be understood to be computer-implemented.

In some embodiments, the wireless communications network 100 may support NR.

The method may comprise one or more of the following actions. In some embodiments, all the actions may be performed. In other embodiments, some of the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first network node 111 is depicted in FIG. 4. In FIG. 4, optional actions in some embodiments may be represented with dashed lines. In some embodiments, the actions may be performed in a different order than that depicted FIG. 4.

The detailed description of some of the following corresponds to the same references provided above, in relation to the actions described for the wireless device 130 and will thus not be repeated here to simplify the description. For example, the configuration may be to perform the one or more measurements.

### Action 401

In this Action 401, the first network node 111 determines, while the first network node 111 lacks an active connection with the wireless device 130 operating in the wireless communications network 100, whether or not the wireless device 130 is to perform the one or more measurements for broadcast or multicast traffic.

Determining in this Action 401 may comprise deciding or calculating.

In some examples, the determining in this Action 401 may be while the wireless device 130 may lack an active connection with any network node 110 operating in the wireless communications network 100.

The one or more measurements may be quality of experience measurements.

The wireless device 130 lacking the active connection with any network node 110 may be in one of IDLE and INACTIVE mode, that is, IDLE or INACTIVE state.

The determining in this Action 401 of whether or not the wireless device 130 may have to perform one or more measurements may be based on whether or not the wireless device 130 may have the second capability to perform the one or more measurements.

In some embodiments, the determining in this Action 401 of whether or not the wireless device 130 may have to perform the one or more measurements for broadcast or multicast traffic may be based on at least one of: a) whether or not the wireless device 130 may intend to receive the broadcast or multicast traffic, b) whether or not the wireless device 130 may determine that the broadcast or multicast traffic has already started, c) whether or not the wireless device 130 may have the first capability to receive broadcast receptions, and d) whether or not the wireless device 130 may have the second capability to perform the one or more measurements.

In some embodiments, the determining in this this this Action 401 of whether or not the wireless device 130 may have to perform the one or more measurements for broadcast or multicast traffic may be responsive to the wireless device 130 having determined, while the wireless device 130 may lack the active connection with any network node 110, that it may desire to receive at least one of broadcast and multicast traffic, e.g., after having received another indication from the wireless device 130 indicating that the wireless device 130 desires to receive the at least one of broadcast and multicast traffic. In some of these embodiments, the determining in Action 401 of whether or not to establish the connection with the wireless device 130 may further comprise determining whether or not the wireless device 130 may have a valid configuration to perform the one or more measurements.

### Action 402

In this Action 402, the first network node 111 sends the first indication to the wireless device 130, e.g., via the first link 141.

The sending in this Action 402 is based on a result of the determination performed in Action 401.

The first indication indicates whether or not the wireless device 130 is to perform the one or more measurements.

In some embodiments, the first indication may further indicate whether or not the wireless device 130 may have to perform the one or more measurements, per type of traffic.

In some embodiments, the first indication may be sent in a broadcast message.

In some embodiments, the first indication may explicitly indicate the configuration may have to be fetched for a broadcast reception.

### Action 403

In this Action 403, first network node 111 establishes the connection with the wireless device 130.

The establishing in this Action 403 of the connection with the wireless device 130 is based on the result of the determination performed in Action 401.

The establishing in this Action 403 of the connection with the wireless device 130 is after having sent the first indication.

With the proviso the first network node 111 establishes the connection, the first network node 111 is enabled to provide the configuration to perform the one or more measurements.

As stated earlier, in some embodiments, the determining in Action 401 of whether or not the wireless device 130 is to perform the one or more measurements for broadcast or multicast traffic may be responsive to the wireless device 130 having determined, while the wireless device 130 may lack the active connection with any network node 110, that it may desire to receive at least one of broadcast and multicast traffic, e.g., after having received another indication from the wireless device 130 indicating that the wireless device 130 desires to receive the at least one of broadcast and multicast traffic. In some of these embodiments, the determining in Action 401 of whether or not to establish the connection with the wireless device 130 may further comprise determining whether or not the wireless device 130 may have a valid configuration to perform the one or more measurements. In some of these embodiments, the establishing in Action 403 may be performed with the proviso that the wireless device 130 may lack the valid configuration. This may be, e.g., autonomously confirmed by the first network node 111, or indicated by the wireless device 130.

In some embodiments, the establishing in this Action 403 may be performed with the proviso that the wireless device 130 may have the first capability to receive broadcast reception.

In some embodiments, the establishing in this Action 403 may be performed with the proviso the wireless device 130 may have the second capability to perform the one or more measurements.

### Action 404

In this Action 404, the first network node 111 may receive the second indication.

The receiving in Action 404 may be from the wireless device 130, e.g., via the first link 141.

The second indication may indicate that the configuration is requested.

In some embodiments, the second indication may indicate, explicitly or implicitly, which type of traffic broadcast or multicast the one or more measurements may have to be performed on.

### Action 405

In this Action 405, the first network node 111 may determine whether or not to provide the configuration to the wireless device 130.

Determining in this Action 405 may comprise deciding or calculating.

### Action 406

In this Action 406, the first network node 111 may provide the configuration.

The providing in this Action 406 may be to the wireless device 130.

The providing in this Action 406 of the configuration may be performed, after establishing the connection, based on a result of the determining in Action 405 of whether or not to provide the configuration to the wireless device 130.

In some embodiments, the providing in this Action 406 of the configuration may be in one of: a broadcast channel, a dedicated channel and a unicast channel.

In some embodiments, the providing in this Action 406 of the configuration may be in one of: the broadcast channel, the dedicated channel and the unicast channel, based on the state of the wireless device 130.

In some embodiments, the broadcast channel may be one of MCCH and MTCH.

In some embodiments, the providing in this Action 406 of the configuration may be in dedicated RRC signalling.

### Action 407

In this Action 407, the first network node 111 may receive the third indication.

The receiving in this Action 407 may be from the wireless device 130, e.g., via the first link 141.

The third indication may indicate the one or more measurements performed by the wireless device 130 according to the configuration.

### Action 408

In some embodiments, the method may send the fourth indication.

The sending in this Action 408 may be to the wireless device 130, e.g., via the first link 141.

The sending in this Action 408 may be after having received the third indication from the wireless device 130, the third indication indicating that the wireless device 130 has performed the one or more measurements according to the configuration.

The fourth indication may indicate, e.g., whether or not the wireless device 130 may have to return to a mode wherein the wireless device 130 may lack a connection with any network node 110 operating in the wireless communications network 100.

The fourth indication may indicate the wireless device 130 may have to return to one of IDLE and INACTIVE state.

Certain embodiments disclosed herein may provide one or more of the following technical advantage(s), which may be summarized as follows.

Embodiments herein, may be understood to enable that the first network node 111 may provide the QoE configuration to the wireless device 130 directly when it may be needed. That may be understood to mean that the UEs may start performing the measurements at the desired time. Hence, more measurements may be collected, and the first network node 111 may perform better analysis of the end users experience and take relevant actions.

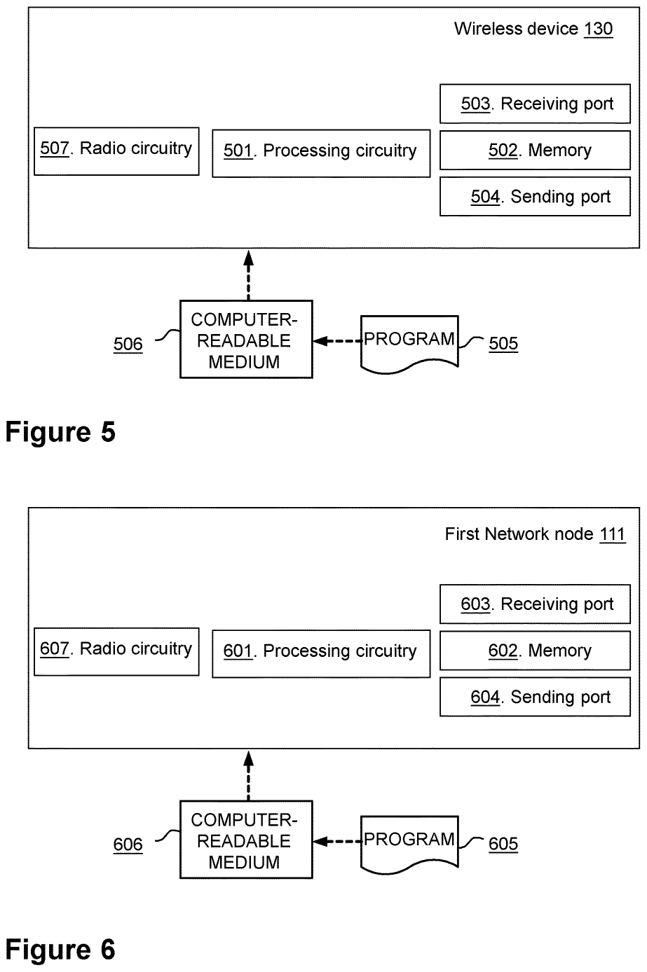

FIG. 5 depicts an example of the arrangement that the wireless device 130 may comprise to perform the method actions described above in relation to FIG. 3. The wireless device 130 may be understood to be for handling the configuration. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the configuration may be configured to be to perform the one or more measurements.

In FIG. 5, optional units are indicated with dashed boxes.

The wireless device 130 is configured to perform the determining of Action 302, e.g. by means of a processing circuitry 501 within the wireless device, configured to determine, while the wireless device 130 lacks an active connection with any network node 110 configured to operate in the wireless communications network 100, whether or not the wireless device 130 is to perform one or more measurements for broadcast or multicast traffic.

The wireless device 130 is configured to perform the determining in Action 303, e.g. by means of the processing circuitry 501 within the wireless device 130, configured to determine, based on the first result of the determination, whether or not to establish a connection with the first network node 111 configured to operate in the wireless communications network 100 to receive the configuration. The configuration is configured to be to perform the one or more measurements.

The wireless device 130 is configured to perform the establishing in Action 304, e.g., by means of the processing circuitry 501, configured to establish the connection with the first network node 111 based on the second result of the determination of whether or not to establish the connection.

In some embodiments, the one or more measurements may be quality of experience measurements.

In some embodiments, the wireless device 130 may be configured with at least one of the following two configurations

The wireless device 130 may be configured to perform the receiving in Action 301, e.g. by means of the processing circuitry 501, configured to receive the first indication from the first network node 111. The first indication may be configured to indicate whether or not the wireless device 130 may have to perform the one or more measurements. The determining of whether or not the wireless device 130 may have to perform one or more measurements may be configured to be based on the first indication configured to be received.

The wireless device 130 may be configured to perform the sending in Action 305, e.g. by means of the processing circuitry 501 within the wireless device 130, configured to send the second indication to the first network node 111. The second indication may be configured to indicate that the configuration is requested.

In some embodiments, at least one of the following may apply: a) the first wireless device 130 may be configured to receive the first indication and the first indication may be further configured to indicate whether or not the wireless device 130 may have to perform the one or more measurements, per type of traffic, b) the first wireless device 130 may be configured to receive the first indication and the first indication may be configured to be received in a broadcast message, c) the first wireless device 130 may be configured to receive the first indication and the first indication may explicitly indicate the configuration may have to be fetched for a broadcast reception, and d) the first wireless device 130 may be configured to send the second indication and the second indication may be configured to indicate, explicitly or implicitly, which type of broadcast or multicast traffic the one or more measurements may have to be performed on.

In some embodiments, the determining of whether or not to establish the connection with the first network node 111 may be configured to be based on at least one of: a) whether or not the wireless device 130 may intend to receive the broadcast or multicast traffic, b) whether or not the wireless device 130 may determine that the broadcast or multicast traffic may have already started, c) whether or not the wireless device 130 may be configured to have the first capability to receive broadcast receptions, and d) whether or not the wireless device 130 may be configured to have the second capability to perform the one or more measurements.

In some embodiments, that the establishing is configured to be based on the second result may be configured to comprise refraining from establishing the connection with the proviso that at least one of: a) the wireless device 130 may not be intending to receive the broadcast or multicast traffic, b) the wireless device 130 may determine that the broadcast or multicast traffic may have already started, c) the wireless device 130 may be configured to lack the first capability to receive broadcast receptions, and d) the wireless device 130 may be configured to lack the second capability to perform the one or more measurements.

In some embodiments, the determining of whether or not the wireless device 130 is to perform the one or more measurements may be configured to be responsive to the wireless device 130 having determined, while the wireless device 130 may lack the active connection with any network node 110, that the wireless device 130 may desire to receive at least one of broadcast and multicast traffic.

In some embodiments, the determining of whether or not to establish the connection with the first network node 111 may be configured to further comprise determining whether or not the wireless device 130 may have the valid configuration to perform the one or more measurements.

In some embodiments, the establishing may be configured to be performed with the proviso that the wireless device 130 may have determined the wireless device 130 lacks the valid configuration

In some embodiments, the wireless device 130 may be further configured with at least one of the following four configurations.

The wireless device 130 may be configured to perform the acquiring of Action 306, e.g. by means of the processing circuitry 501 within the wireless device 130, configured to acquire the configuration from the first network node 111 after establishing the connection.

The wireless device 130 may be configured to perform the performing of Action 307, e.g. by means of the processing circuitry 501 within the wireless device 130, configured to perform the one or more measurements according to the configuration.

The wireless device 130 may be configured to perform the sending in Action 308, e.g. by means of the processing circuitry 501, configured to send the third indication configured to indicate the performed one or more measurements according to the configuration.

The wireless device 130 may be configured to perform the receiving in Action 309, e.g. by means of the processing circuitry 501 within the wireless device 130, configured to receive, after having performed the one or more measurements according to the configuration, the fourth indication from the first network node 111. The fourth indication may be configured to indicate whether or not the wireless device 130 may have to return to a mode wherein the wireless device 130 may lacks a connection with any network node 110 configured to operate in the wireless communications network 100.

In some embodiments, the fourth indication may be configured to indicate the wireless device 130 may have to return to one of IDLE and INACTIVE state.

In some embodiments, at least one of the following may apply: i) the wireless device 130 lacking the active connection with any network node 110 may be configured to be in one of IDLE and INACTIVE mode, ii) the establishing may be configured to be performed with the proviso that the wireless device 130 may be configured to have the first capability to receive broadcast reception, iii) the establishing may be configured to be performed with the proviso the wireless device 130 may be configured to have the second capability to perform the one or more measurements, iv) the acquiring of the configuration may be configured to be in one of: the broadcast channel, the dedicated channel and the unicast channel, v) the acquiring of the configuration may be configured to be in one of: the broadcast channel, the dedicated channel and the unicast channel, based on the state of the wireless device 130, vi) the broadcast channel may be configured to be one of MCCH and MTCH, and vii) the acquiring of the configuration may be configured to be in dedicated Radio Resource Control signalling.

The embodiments herein in the wireless device 130 may be implemented through one or more processors, such as a processing circuitry 501 in the wireless device 130 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The processing circuitry 501 may be configured to, or operable to, perform the method actions according to FIG. 3.

The wireless device 130 may further comprise a memory 502 comprising one or more memory units. The memory 502 is arranged to be used to store obtained information, store data, configurations, schedulings, and applications etc. to perform the methods herein when being executed in the wireless device 130.

In some embodiments, the wireless device 130 may receive information from, e.g., the first network node 111 or another structure in the wireless communications network 100, through a receiving port 503. In some embodiments, the receiving port 503 may be, for example, connected to one or more antennas in wireless device 130. In other embodiments, the wireless device 130 may receive information from another structure in the wireless communications network 100 through the receiving port 503. Since the receiving port 503 may be in communication with the processing circuitry 501, the receiving port 503 may then send the received information to the processing circuitry 501. The receiving port 503 may also be configured to receive other information.

The processing circuitry 501 in the wireless device 130 may be further configured to transmit or send information to e.g., the first network node 111 or another structure in the wireless communications network 100, through a sending port 504, which may be in communication with the processing circuitry 501, and the memory 502.

Those skilled in the art will also appreciate that the processing circuitry 501 described above may comprise a combination of analog and digital modules, and/or one or more processors configured with software and/or firmware, e.g., stored in memory, that, when executed by the one or more processors such as the processing circuitry 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 130 may be configured to perform the actions of FIG. 3 with respective units that may be implemented as one or more applications running on one or more processors such as the processing circuitry 501.

Thus, the methods according to the embodiments described herein for the wireless device 130 may be respectively implemented by means of a computer program 505 product, comprising instructions, i.e., software code portions, which, when executed on at least one processing circuitry 501, cause the at least one processing circuitry 501 to carry out the actions described herein, as performed by the wireless device 130. The computer program 505 product may be stored on a computer-readable storage medium 506. The computer-readable storage medium 506, having stored thereon the computer program 505, may comprise instructions which, when executed on at least one processing circuitry 501, cause the at least one processing circuitry 501 to carry out the actions described herein, as performed by the wireless device 130. In some embodiments, the computer-readable storage medium 506 may be a non-transitory computer-readable storage medium, such as a CD ROM disc, or a memory stick. In other embodiments, the computer program 505 product may be stored on a carrier containing the computer program 505 just described, wherein the carrier is one of an electronic signal, optical signal, radio signal, or the computer-readable storage medium 506, as described above.

The wireless device 130 may comprise a communication interface configured to facilitate communications between the wireless device 130 and other nodes or devices, e.g., the first network node 111 or another structure in the wireless communications network 100. The interface may, for example, include a transceiver configured to transmit and receive radio signals over an air interface in accordance with a suitable standard.

In other embodiments, the wireless device 130 may also comprise a radio circuitry 507, which may comprise e.g., the receiving port 503 and the sending port 504. The radio circuitry 507 may be configured to set up and maintain at least a wireless connection with the first network node 111 or another structure in the wireless communications network 100. Circuitry may be understood herein as a hardware component.

Hence, embodiments herein also relate to the wireless device 130 comprising the processing circuitry 501 and the memory 502, said memory 502 containing instructions executable by said processing circuitry 501, whereby the wireless device 130 is operative to perform the actions described herein in relation to the wireless device 130, e.g., in FIG. 3.

FIG. 6 depicts an example of the arrangement that the first network node 111 may comprise to perform the method actions described above in relation to FIG. 4. The network node 110 may be understood to be for handling the configuration of the wireless device 130. The network node 110 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the configuration may be configured to be to perform the one or more measurements.

In FIG. 6, optional units are indicated with dashed boxes.

The first network node 111 is configured to perform the determining of Action 401, e.g. by means of a processing circuitry 601 within the first network node 111, configured to determine, while the first network node 111 lacks an active connection with the wireless device 130 configured to operate in the wireless communications network 100, whether or not the wireless device 130 is to perform one or more measurements for broadcast or multicast traffic.

The first network node 111 is configured to perform the sending of Action 402, e.g. by means of the processing circuitry 601, configured to send, based on a result of the determination, the first indication to the wireless device 130. The first indication is configured to indicate whether or not the wireless device 130 is to perform the one or more measurements.

The first network node 111 is configured to perform the establishing of Action 403, e.g. by means of the processing circuitry 601 within the first network node 111, configured to establish the connection with the wireless device 130 based on the result of the determination, and after having sent the first indication. Additionally, with the proviso the first network node 111 establishes the connection, the first network node 111 is configured to be enabled to provide the configuration to perform the one or more measurements.

In some embodiments, at least one of the following may apply: a) the one or more measurements may be configured to be quality of experience measurements, b) the first indication may be further configured to indicate whether or not the wireless device 130 may have to perform the one or more measurements, per type of traffic, c) the first indication may be configured to be sent in a broadcast message, and d) the first indication may be configured to explicitly indicate the configuration may have to be fetched for a broadcast reception.

The first network node 111 may be configured to perform the receiving of Action 404, e.g. by means of the processing circuitry 601, configured to receive the second indication from the wireless device 130. The second indication may be configured to indicate that the configuration is requested.

In some embodiments, the second indication may be configured to indicate, explicitly or implicitly, which type of broadcast or multicast traffic the one or more measurements may have to be performed on.

In some embodiments, the determining of whether or not the wireless device 130 may have to perform one or more measurements for broadcast or multicast traffic may be based on at least one of: a) whether or not the wireless device 130 may intend to receive the broadcast or multicast traffic, b) whether or not the wireless device 130 may determine that the broadcast or multicast traffic may have already started, c) whether or not the wireless device 130 may be configured to have the first capability to receive broadcast receptions, and d) whether or not the wireless device 130 may be configured to have the second capability to perform the one or more measurements.

In some embodiments, the determining of whether or not the wireless device 130 may have to perform the one or more measurements may be configured to be responsive to the wireless device 130 having determined, while the wireless device 130 lacks the active connection with any network node 110, that it desires to receive at least one of broadcast and multicast traffic. The determining of whether or not to establish the connection with the wireless device 130 may be further configured to comprise determining whether or not the wireless device 130 may have a valid configuration to perform the one or more measurements. The establishing may be configured to be performed with the proviso that the wireless device 130 may lacks the valid configuration

In some embodiments, the network node 110 may be further configured with at least one of the following four configurations.

The first network node 111 may be configured to perform the determining of Action 405, e.g. by means of the processing circuitry 601 within the first network node 111, configured to determine whether or not to provide the configuration to the wireless device 130.

The first network node 111 may be configured to perform the providing of Action 406, e.g., by means of the processing circuitry 601, configured to provide the configuration to the wireless device 130 after establishing the connection, based on the result of the determining of whether or not to provide the configuration to the wireless device 130.

The first network node 111 may be configured to perform the receiving of Action 407, e.g. by means of the processing circuitry 601, configured to receive the third indication from the wireless device 130. The third indication may be configured to indicate the one or more measurements performed by the wireless device 130 according to the configuration.

The first network node 111 may be configured to perform the sending of Action 408, e.g. by means of the processing circuitry 601, configured to send, after having received the third indication from the wireless device 130, the third indication being configured to indicate that the wireless device 130 has performed the one or more measurements according to the configuration, the fourth indication to the wireless device 130. The fourth indication may be configured to indicate whether or not the wireless device 130 may have to return to a mode wherein the wireless device 130 may lack a connection with any network node 110 configured to operate in the wireless communications network 100.

In some embodiments, the fourth indication may be configured to indicate the wireless device 130 may have to return to one of IDLE and INACTIVE state.

In some embodiments, at least one of the following may apply: i) the wireless device 130 lacking the active connection with any network node 110 may be configured to be in one of IDLE and INACTIVE mode, ii) the establishing may be configured to be performed with the proviso that the wireless device 130 may be configured to have the first capability to receive broadcast reception, iii) the determining may be configured to be based on whether or not the wireless device 130 may be configured to have the second capability to perform the one or more measurements iv) the establishing may be configured to be performed with the proviso the wireless device 130 may be configured to have the second capability to perform the one or more measurements, v) the providing of the configuration may be configured to be in one of: the broadcast channel, the dedicated channel and the unicast channel, vi) the providing of the configuration may be configured to be in one of: the broadcast channel, the dedicated channel and the unicast channel, based on the state of the wireless device 130, vii) the broadcast channel may be configured to be one of MCCH and MTCH, and vii) the providing of the configuration may be configured to be in dedicated Radio Resource Control signalling.

The embodiments herein in the first network node 111 may be implemented through one or more processors, such as a processing circuitry 601 in the first network node 111 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The processing circuitry 601 may be configured to, or operable to, perform the method actions according to FIG. 4.

The first network node 111 may further comprise a memory 602 comprising one or more memory units. The memory 602 is arranged to be used to store obtained information, store data, configurations, schedulings, and applications etc. to perform the methods herein when being executed in the first network node 111.

In some embodiments, the first network node 111 may receive information from, e.g., the wireless device 130 and/or another structure in the wireless communications network 100, through a receiving port 603. In some embodiments, the receiving port 603 may be, for example, connected to one or more antennas in first network node 111. In other embodiments, the first network node 111 may receive information from another structure in the wireless communications network 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the first network node 111 may be further configured to transmit or send information to e.g., the wireless device 130 and/or another structure in the wireless communications network 100, through a sending port 604, which may be in communication with the processing circuitry 601, and the memory 602.

Those skilled in the art will also appreciate that the processing circuitry 601 described above may comprise a combination of analog and digital modules, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the first network node 111 may be configured to perform the actions of FIG. 4 with respective units that may be implemented as one or more applications running on one or more processors such as the processing circuitry 601.

Thus, the methods according to the embodiments described herein for the first network node 111 may be respectively implemented by means of a computer program 605 product, comprising instructions, i.e., software code portions, which, when executed on at least one processing circuitry 601, cause the at least one processing circuitry 601 to carry out the actions described herein, as performed by the first network node 111. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the first network node 111. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The first network node 111 may comprise a communication interface configured to facilitate communications between the first network node 111 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the first network node 111 may also comprise a radio circuitry 607, which may comprise e.g., the receiving port 603 and the sending port 604. The radio circuitry 607 may be configured to set up and maintain at least a wireless connection with the wireless device 130 and/or another structure in the wireless communications network 100. Circuitry may be understood herein as a hardware component.

Hence, embodiments herein also relate to the first network node 111 comprising the processing circuitry 601 and the memory 602, said memory 602 containing instructions executable by said processing circuitry 601, whereby the first network node 111 is operative to perform the actions described herein in relation to the first network node 111, e.g., in FIG. 4.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

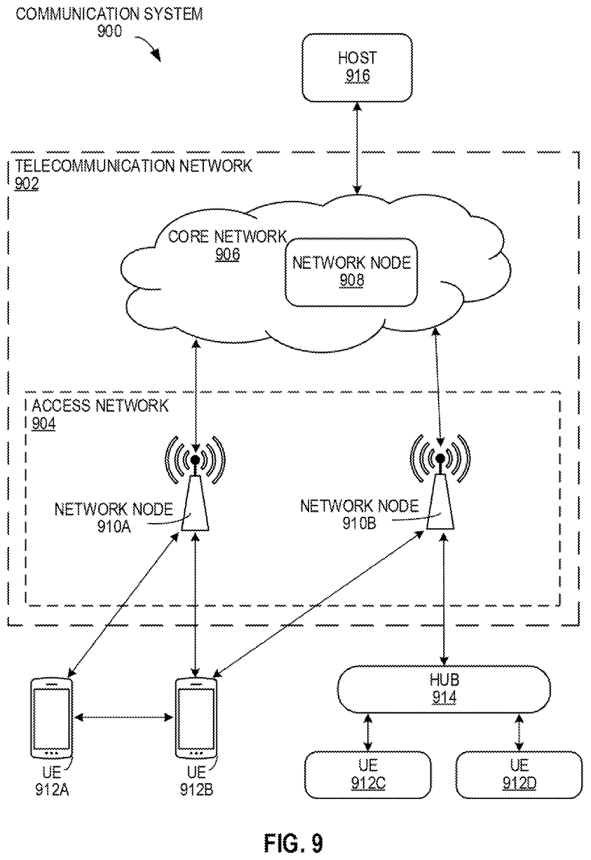

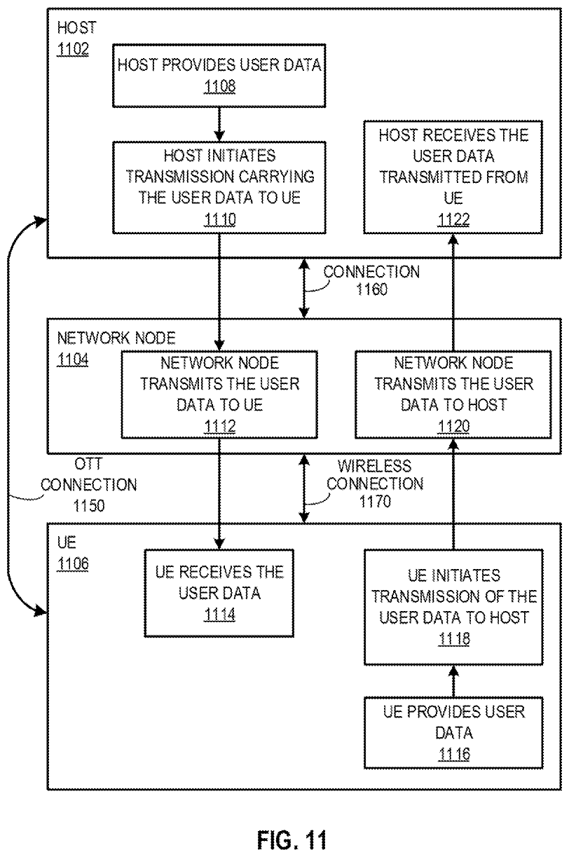

The wireless device 130 examples relate to FIG. 3, FIG. 5, FIG. 9 and FIG. 11.

A method, performed by a wireless device, such as the wireless device 130 is described herein. The method may be understood to be for handling a configuration. The wireless device 130 may be operating in a wireless communications network, such as the wireless communications network 100.

In some examples, the wireless communications network 100 may support New Radio (NR).

The method may comprise one or more of the following actions. In some examples, all the actions may be performed. In other examples, some of the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the wireless device 130 is depicted in FIG. 3. In FIG. 3, optional actions in some examples may be represented with dashed lines. In some examples, the actions may be performed in a different order than that depicted FIG. 3.
Determining 702 whether or not the wireless device 130 is to perform one or more measurements. The wireless device 130 may be configured to perform the determining of this Action 702, e.g. by means of a processing circuitry 501 within the wireless device, configured to perform this action.

Determining in this Action 702 may comprise deciding or calculating.

The determining in this Action 702 may be while the wireless device 130 may lack an active connection with any network node 110 operating in the wireless communications network 100.

The one or more measurements may be for broadcast or multicast traffic.

The one or more measurements may be quality of experience measurements.

The wireless device 130 lacking the active connection with any network node 110 may be in one of IDLE and INACTIVE mode.
Determining 703 whether or not to establish the connection with the first network node 111 operating in the wireless communications network 100. The wireless device 130 may be configured to perform the determining in this Action 703, e.g. by means of the processing circuitry 501 within the wireless device 130, configured to perform this action.

Determining in this Action 703 may comprise deciding or calculating.

The determining in this Action 703 may be of whether or not to establish the connection with the first network node 111 in order to receive the configuration.

The configuration may be to perform the one or more measurements

The determining in this Action 703 may be based on a first result of the determination in Action 705.

In some examples, the determining in this Action 703 of whether or not to establish the connection with the first network node 111 may be based on at least one of:
whether or not the wireless device 130 may intend to receive the traffic,
whether or not the wireless device 130 may determine that the traffic has already started,
whether or not the wireless device 130 may have a first capability to receive broadcast receptions, and
whether or not the wireless device 130 may have a second capability to perform the one or more measurements.
   Establishing 704 the connection with the first network node 111 operating in the wireless communications network 100. The wireless device 130 may be configured to perform the establishing in this Action 704, e.g., by means of the processing circuitry 501, configured to perform this action.

The establishing in this Action 704 of the connection with the first network node 111 may be, based on a second result of the determination of whether or not to establish the connection in Action 703.

In some examples, that the establishing in this Action 704 may be based on the second result may comprise refraining from establishing the connection with the proviso that at least one of:
the wireless device 130 may not be intending to receive the traffic,
the wireless device 130 may determine that the traffic has already started,
the wireless device 130 may lack the first capability to receive broadcast receptions, and
the wireless device 130 may lack the second capability to perform the one or more measurements.

In some examples, the determining in Action 702 of whether or not the wireless device 130 is to perform the one or more measurements may be responsive to the wireless device 130 having determined, while the wireless device 130 may lack the active connection with any network node 110, that it may desire to receive at least one of broadcast and multicast traffic. In some of these examples, the determining in Action 703 of whether or not to establish the connection with the first network node 111 may further comprise determining whether or not the wireless device 130 may have a valid configuration to perform the one or more measurements. In some of these examples, the establishing in Action 704 may be performed with the proviso that the wireless device 130 may have determined the wireless device 130 may lack the valid configuration.

In some examples, the establishing in this Action 704 may be performed with the proviso that the wireless device 130 may have a first capability to receive broadcast reception.

In some examples, the establishing in this Action 704 may be performed with the proviso the wireless device 130 may have a second capability to perform the one or more measurements.

In some examples, the method may further comprise one or more of the following actions:
Receiving 701 a first indication. The wireless device 130 may be configured to perform the receiving in this Action 701, e.g. by means of the processing circuitry 501, configured to perform this action.

The receiving in this Action 701 may be from the first network node 111.

The first indication may indicate whether or not the wireless device 130 may have to perform the one or more measurements. The determining in Action 702 of whether or not the wireless device 130 may have to perform one or more measurements may be based on the received first indication.

The receiving in this Action 701 may be performed, e.g., via the first link 141.

In some examples, the first indication may further indicate whether or not the wireless device 130 may have to perform the one or more measurements, per type of traffic.

In some examples, the first indication may be received in a broadcast message.

In some examples, the first indication may explicitly indicate the configuration may have to be fetched for a broadcast reception.
Sending 705 a second indication. The wireless device 130 may be configured to perform the sending in this Action 705, e.g. by means of the processing circuitry 501 within the wireless device 130, configured to perform this action.

The sending in this Action 705 may be to the first network node 111.

The sending in this Action 705 may be, e.g., transmitting, and may be performed, e.g., via the first link 141.

The second indication may indicate that the configuration is requested.

In some examples, the second indication may indicate, explicitly or implicitly, which type of traffic the one or more measurements may have to be performed on.
Acquiring 706 the configuration. The wireless device 130 may be configured to perform the acquiring of this Action 706, e.g. by means of the processing circuitry 501 within the wireless device 130, configured to perform this action.

The acquiring in this Action 706 may be from the first network node 111 after establishing the connection.

In some examples, the acquiring in this Action 706 of the configuration may be in one of: a broadcast channel, a dedicated channel and a unicast channel.

In some examples, the acquiring in this Action 706 of the configuration may be in one of: the broadcast channel, the dedicated channel and the unicast channel, based on a state of the wireless device 130,

In some examples, the broadcast channel may be one of Multicast Broadcast Control Channel (MCCH), and Multicast Broadcast Transmission Channel (MTCH).

In some examples, the acquiring in this Action 706 of the configuration may be in dedicated Radio Resource Control (RRC) signalling.
Performing 707 the one or more measurements according to the configuration. The wireless device 130 may be configured to perform the performing of this Action 707, e.g. by means of the processing circuitry 501 within the wireless device 130, configured to perform this action.
Sending 708 a third indication. The wireless device 130 may be configured to perform the sending in this Action 708, e.g. by means of the processing circuitry 501, configured to perform this action.

The sending in this Action 708 may be to the first network node 111.

The third indication may indicate the performed one or more measurements according to the configuration.
Receiving 709 a fourth indication. The wireless device 130 may be configured to perform the receiving in this Action 709, e.g. by means of the processing circuitry 501 within the wireless device 130, configured to perform this action.

The receiving in this Action 709 may be from the first network node 111, e.g., via the first link 141.

The receiving in this Action 709 may be after having performed the one or more measurements according to the configuration.

The fourth indication may indicate, e.g., whether or not the wireless device 130 may have to return to a mode wherein the wireless device 130 may lack a connection with any network node 110 operating in the wireless communications network 100.

The fourth indication may indicate the wireless device 130 may have to return to one of IDLE and INACTIVE state.

In FIG. 5, optional units are indicated with dashed boxes.

The wireless device 130 may also be configured to communicate user data with a host application unit in a host 916, 1000, 1102, e.g., via an OTT connection such as OTT connection 1150.

The wireless device 130 may comprise an interface unit to facilitate communications between the wireless device 130 and other nodes or devices, e.g., the first network node 111, the host 916, 1000, 1102, or any of the other nodes. In some particular examples, the interface may, for example, include a transceiver configured to transmit and receive radio signals over an air interface in accordance with a suitable standard.

The first network node 111 examples relate to FIG. 4, FIG. 6, FIG. 9 and FIG. 11.

A method, performed by a first network node, such as the first network node 111 is described herein. The method may be understood to be for handling the configuration of the wireless device, such as the wireless device 130. The first network node 111 may be operating in a wireless communications network, such as the wireless communications network 100.

In some examples, the wireless communications network 100 may support New Radio (NR).

The method may comprise one or more of the following actions. In some examples, all the actions may be performed. In other examples, some of the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the first network node 111 is depicted in FIG. 4. In FIG. 4, optional actions in some examples may be represented with dashed lines. In some examples, the actions may be performed in a different order than that depicted FIG. 4.

The detailed description of some of the following corresponds to the same references provided above, in relation to the actions described for the wireless device 130 and will thus not be repeated here to simplify the description. For example, the configuration may be to perform the one or more measurements.
Determining 801 whether or not the wireless device 130 is to perform the one or more measurements. The first network node 111 may be configured to perform the determining of this Action 801, e.g. by means of a processing circuitry 601 within the first network node 111, configured to perform this action.

Determining in this Action 801 may comprise deciding or calculating.

The determining in this Action 801 may be while the first network node 111 may lack an active connection with the wireless device 130 operating in the wireless communications network 100/while the wireless device 130 may lack an active connection with any network node 110 operating in the wireless communications network 100.

The one or more measurements may be quality of experience measurements.

The one or more measurements may be on broadcast or multicast traffic.

The wireless device 130 lacking the active connection with any network node 110 may be in one of IDLE and INACTIVE mode.

The determining in Action 801 of whether or not the wireless device 130 may have to perform one or more measurements may be based on whether or not the wireless device 130 may have the second capability to perform the one or more measurements.
Sending 802 the first indication. The first network node 111 may be configured to perform the sending of this Action 802, e.g. by means of the processing circuitry 601, configured to perform this action.

The sending in this Action 801 may be to the wireless device 130, e.g., via the first link 141.

The sending in this Action 802 may be based on a result of the determination performed in Action 801.

The first indication may indicate whether or not the wireless device 130 may have to perform the one or more measurements.

In some examples, the first indication may further indicate whether or not the wireless device 130 may have to perform the one or more measurements, per type of traffic.

In some examples, the first indication may be sent in a broadcast message.

In some examples, the first indication may explicitly indicate the configuration may have to be fetched for a broadcast reception.
Establishing 803 the connection with the wireless device 130. The first network node 111 may be configured to perform the establishing of this Action 803, e.g. by means of the processing circuitry 601 within the first network node 111, configured to perform this action.

The establishing in this Action 803 of the connection with the wireless device 130 may be, based on the result of the determination performed in Action 801.

The establishing in this Action 803 of the connection with the wireless device 130 may be after having sent the first indication.

In some examples, the determining in Action 801 of whether or not the wireless device 130 may have to perform the one or more measurements for broadcast or multicast traffic may be based on at least one of:
whether or not the wireless device 130 may intend to receive the traffic,
whether or not the wireless device 130 may determine that the traffic has already started,
whether or not the wireless device 130 may have the first capability to receive broadcast receptions, and
whether or not the wireless device 130 may have the second capability to perform the one or more measurements.

In some examples, the determining in Action 801 of whether or not the wireless device 130 is to perform the one or more measurements may be responsive to the wireless device 130 having determined, while the wireless device 130 may lack the active connection with any network node 110, that it may desire to receive at least one of broadcast and multicast traffic, e.g., after having received another indication from the wireless device 130 indicating that the wireless device 130 desires to receive the at least one of broadcast and multicast traffic. In some of these examples, the determining in Action 801 of whether or not to establish the connection with the wireless device 130 may further comprise determining whether or not the wireless device 130 may have a valid configuration to perform the one or more measurements. In some of these examples, the establishing in Action 803 may be performed with the proviso that the wireless device 130 may lack the valid configuration. This may be, e.g., autonomously confirmed by the first network node 111, or indicated by the wireless device 130.

In some examples, the establishing in this Action 803 may be performed with the proviso that the wireless device 130 may have the first capability to receive broadcast reception.

In some examples, the establishing in this Action 803 may be performed with the proviso the wireless device 130 may have the second capability to perform the one or more measurements.

In some examples, the method may further comprise one or more of the following actions:
Receiving 804 the second indication. The first network node 111 may be configured to perform the receiving of this Action 804, e.g. by means of the processing circuitry 601, configured to perform this action.

The receiving in Action 804 may be from the wireless device 130, e.g., via the first link 141.

The second indication may indicate that the configuration is requested.

In some examples, the second indication may indicate, explicitly or implicitly, which type of traffic the one or more measurements may have to be performed on.
Determining 805 whether or not to provide the configuration to the wireless device 130. The first network node 111 may be configured to perform the determining of this Action 805, e.g. by means of the processing circuitry 601 within the first network node 111, configured to perform this action.

Determining in this Action 805 may comprise deciding or calculating.
Providing 806 the configuration. The first network node 111 may be configured to perform the providing of this Action 806, e.g., by means of the processing circuitry 601, configured to perform this action.

The providing in this Action 806 may be to the wireless device 130.

The providing in this Action 806 of the configuration may be performed, after establishing the connection, e.g., based on a result of the determining 805 of whether or not to provide the configuration to the wireless device 130.

In some examples, the providing in this Action 806 of the configuration may be in one of: a broadcast channel, a dedicated channel and a unicast channel.

In some examples, the providing in this Action 806 of the configuration may be in one of: the broadcast channel, the dedicated channel and the unicast channel, based on the state of the wireless device 130.

In some examples, the broadcast channel may be one of MCCH and MTCH.

In some examples, the providing in this Action 806 of the configuration may be in dedicated RRC signalling.
Receiving 807 the third indication. The first network node 111 may be configured to perform the receiving of this Action 807, e.g. by means of the processing circuitry 601, configured to perform this action.

The receiving in this Action 807 may be from the wireless device 130, e.g., via the first link 141.

The third indication may indicate the one or more measurements performed by the wireless device 130 according to the configuration.
Sending 808 the fourth indication. The first network node 111 may be configured to perform the sending of this Action 808, e.g. by means of the processing circuitry 601, configured to perform this action.

The sending in this Action 808 may be to the wireless device 130, e.g., via the first link 141.

The sending in this Action 808 may be after having received the third indication from the wireless device 130, the third indication indicating that the wireless device 130 has performed the one or more measurements according to the configuration.

The fourth indication may indicate, e.g., whether or not the wireless device 130 may have to return to a mode wherein the wireless device 130 may lack a connection with any network node 110 operating in the wireless communications network 100.

The fourth indication may indicate the wireless device 130 may have to return to one of IDLE and INACTIVE state.

In FIG. 6, optional units are indicated with dashed boxes.

The first network node 111 may also be configured to communicate user data with a host application unit in a host 916, 1000, 1102, e.g., via a connection 1160.

The first network node 111 may comprise an interface unit to facilitate communications between the first network node 111 and other nodes or devices, e.g., the wireless device 130, the host 916, 1000, 1102, or any of the other nodes. In some particular examples, the interface may, for example, include a transceiver configured to transmit and receive radio signals over an air interface in accordance with a suitable standard.

### SELECTED EXAMPLES RELATED TO EXAMPLES HEREIN

EXAMPLE 1. A method performed by a wireless device (130), the method being for handling a configuration, the wireless device (130) operating in a wireless communications network (100), the method comprising:
   determining (702), while the wireless device (130) lacks an active connection with any network node (110) operating in the wireless communications network (100), whether or not the wireless device (130) is to perform one or more measurements for broadcast or multicast traffic,
   determining (703), based on a first result of the determination, whether or not to establish a connection with a first network node (111) operating in the wireless communications network (100) in order to receive the configuration, wherein the configuration is to perform the one or more measurements, and
   establishing (704) the connection with the first network node (111) operating in the wireless communications network (100) based on a second result of the determination of whether or not to establish the connection.
EXAMPLE 2. The method according to example 1, wherein the determining (703) of whether or not to establish the connection with the first network node (111) is based on at least one of:
   whether or not the wireless device (130) intends to receive the traffic,
   whether or not the wireless device (130) determines that the traffic has already started,
   whether or not the wireless device (130) has a first capability to receive broadcast receptions, and
   whether or not the wireless device (130) has a second capability to perform the one or more measurements.
EXAMPLE 3. The method according to example 2, wherein that the establishing (704) is based on the second result comprises refraining from establishing the connection with the proviso that at least one of:
   the wireless device (130) is not intending to receive the traffic,
   the wireless device (130) determines that the traffic has already started,
   the wireless device (130) lacks the first capability to receive broadcast receptions, and
   the wireless device (130) lacks the second capability to perform the one or more measurements.
EXAMPLE 4. The method according to any of examples 1-3, wherein the determining (702) of whether or not the wireless device (130) is to perform the one or more measurements is responsive to the wireless device (130) having determined, while the wireless device (130) lacks the active connection with any network node (110), that it desires to receive at least one of broadcast and multicast traffic, and wherein the determining (703) of whether or not to establish the connection with the first network node (111) further comprises determining whether or not the wireless device (130) has a valid configuration to perform the one or more measurements, and wherein the establishing (704) is performed with the proviso that the wireless device (130) has determined the wireless device (130) lacks the valid configuration.
EXAMPLE 5. The method according to any of examples 1-4, further comprising at least one of:
   receiving (701) a first indication from the first network node (111), the first indication indicating whether or not the wireless device (130) is to perform the one or more measurements, and wherein the determining (702) of whether or not the wireless device (130) is to perform one or more measurements is based on the received first indication,
   sending (705) a second indication to the first network node (111), the second indication indicating that the configuration is requested,
   acquiring (706) the configuration from the first network node (111) after establishing the connection,
   performing (707) the one or more measurements according to the configuration, and
   sending (708) a third indication to the first network node (111), the third indication indicating the performed one or more measurements according to the configuration, and
   receiving (709), after having performed the one or more measurements according to the configuration, a fourth indication from the first network node (111), the fourth indication indicating whether or not the wireless device (130) is to return to a mode wherein the wireless device (130) lacks a connection with any network node (110) operating in the wireless communications network (100), and
EXAMPLE 6. The method according to example 5, wherein at least one of:
   the first indication further indicates whether or not the wireless device (130) is to perform the one or more measurements, per type of traffic,
   the first indication is received in a broadcast message,
   the first indication explicitly indicates the configuration is to be fetched for a broadcast reception,
   the second indication indicates, explicitly or implicitly, which type of traffic the one or more measurements are to be performed on, and
   the fourth indication indicates the wireless device (130) is to return to one of IDLE and INACTIVE state.
EXAMPLE 7. The method according to any of examples 5-6, wherein at least one of:
   i. the one or more measurements are quality of experience measurements,
   ii. the wireless device (130) lacking the active connection with any network node (110) is in one of IDLE and INACTIVE mode,
   iii. the establishing (704) is performed with the proviso that the wireless device (130) has a first capability to receive broadcast reception,
   iv. the establishing (704) is performed with the proviso the wireless device (130) has a second capability to perform the one or more measurements,
   v. the acquiring (706) of the configuration is in one of: a broadcast channel, a dedicated channel and a unicast channel,
   vi. the acquiring (706) of the configuration is in one of: a broadcast channel, a dedicated channel and a unicast channel, based on a state of the wireless device (130), and
   vii. the broadcast channel is one of Multicast Broadcast Control Channel, MCCH, and Multicast Broadcast Transmission Channel, MTCH,
   viii. the acquiring (706) of the configuration is in dedicated Radio Resource Control signalling.
EXAMPLE 8. A method performed by a first network node (111), the method being for handling a configuration of a wireless device (130), the first network node (111) operating in a wireless communications network (100), the method comprising:
determining (801), while the first network node (111) lacks an active connection with the wireless device (130) operating in the wireless communications network (100)/while the wireless device (130) lacks an active connection with any network node (110) operating in the wireless communications network (100), whether or not the wireless device (130) is to perform one or more measurements for broadcast or multicast traffic, and
sending (802), based on a result of the determination, a first indication to the wireless device (130), the first indication indicating whether or not the wireless device (130) is to perform the one or more measurements, and
establishing (803) a connection with the wireless device (130) based on the result of the determination, and after having sent the first indication.
EXAMPLE 9. The method according to example 8, wherein the determining (801) of whether or not the wireless device (130) is to perform one or more measurements for broadcast or multicast traffic is based on at least one of:
   whether or not the wireless device (130) intends to receive the traffic,
   whether or not the wireless device (130) determines that the traffic has already started,
   whether or not the wireless device (130) has a first capability to receive broadcast receptions, and
   whether or not the wireless device (130) has a second capability to perform the one or more measurements.
EXAMPLE 10. The method according to any of examples 8-9, wherein the determining (801) of whether or not the wireless device (130) is to perform the one or more measurements is responsive to the wireless device (130) having determined, while the wireless device (130) lacks the active connection with any network node (110), that it desires to receive at least one of broadcast and multicast traffic, and wherein the determining (801) of whether or not to establish the connection with the wireless device (130) further comprises determining whether or not the wireless device (130) has a valid configuration to perform the one or more measurements, and wherein the establishing (803) is performed with the proviso that the wireless device (130) lacks the valid configuration.
EXAMPLE 11. The method according to any of examples 8-10, further comprising at least one of:
   receiving (804) a second indication from the wireless device (130), the second indication indicating that the configuration is requested,
   determining (805) whether or not to provide the configuration to the wireless device (130),
   providing (806) the configuration to the wireless device (130) after establishing the connection, e.g., based on a result of the determining (805) of whether or not to provide the configuration to the wireless device (130),
   receiving (807) a third indication from the wireless device (130) the third indication indicating the one or more measurements performed by the wireless device (130) according to the configuration, and
   sending (808), after having received the third indication from the wireless device (130), the third indication indicating that the wireless device (130) has performed the one or more measurements according to the configuration, a fourth indication to the wireless device (130), the fourth indication indicating whether or not the wireless device (130) is to return to a mode wherein the wireless device (130) lacks a connection with any network node (110) operating in the wireless communications network (100).
EXAMPLE 12. The method according to example 11, wherein at least one of:
   the first indication further indicates whether or not the wireless device (130) is to perform the one or more measurements, per type of traffic,
   the first indication is sent in a broadcast message,
   the first indication explicitly indicates the configuration is to be fetched for a broadcast reception,
   the second indication indicates, explicitly or implicitly, which type of traffic the one or more measurements are to be performed on, and
   the fourth indication indicates the wireless device (130) is to return to one of IDLE and INACTIVE state.
EXAMPLE 13. The method according to any of examples 11-12, wherein at least one of:
   i. the one or more measurements are quality of experience measurements,
   ii. the wireless device (130) lacking the active connection with any network node (110) is in one of IDLE and INACTIVE mode,
   iii. the establishing (803) is performed with the proviso that the wireless device (130) has a first capability to receive broadcast reception,
   iv. the determining (801) is based on whether or not the wireless device (130) has a second capability to perform the one or more measurements.
   v. the establishing (803) is performed with the proviso the wireless device (130) has a second capability to perform the one or more measurements.
   vi. the providing (806) of the configuration is in one of: a broadcast channel, a dedicated channel and a unicast channel,
   vii. the providing (806) of the configuration is in one of: a broadcast channel, a dedicated channel and a unicast channel, based on a state of the wireless device (130), and
   viii. the broadcast channel is one of Multicast Broadcast Control Channel, MCCH, and Multicast Broadcast Transmission Channel, MTCH,
   ix. the providing (806) of the configuration is in dedicated Radio Resource Control signalling.

### Further Extensions And Variations

FIG. 9 shows an example of a communication system 900 in accordance with some embodiments.

In the example, the communication system 900, such as the wireless communications network 100, includes a telecommunication network 902 that includes an access network 904, such as a radio access network (RAN), and a core network 906, which includes one or more core network nodes 908. The access network 904 includes one or more access network nodes, such as the first network node 111. For example, network nodes 910a and 910b, one or more of which may be generally referred to as network nodes 910, or any other similar 3^{rd} Generation Partnership Project (3GPP) access node or non-3GPP access point. The communications system 900 comprises a plurality of wireless devices, such as the wireless device 130. In FIG. 9, the plurality of wireless devices comprises UEs 912a, 912b, 912c, and 912d, one or more of which may be generally referred to as UEs 912. The network nodes 910 facilitate direct or indirect connection of user equipment (UE), such as by connecting UEs 912a, 912b, 912c, and 912d to the core network 906 over one or more wireless connections. Any of the UEs 912a, 912b, 912c, and 912d are examples of the wireless device 130.

In relation to FIGS. 9, 10, and 11, which are described next, it may be understood that any UE is an example of the wireless device 130, and that any description provided for the UE 912 or for the UE 1106 equally applies to the wireless device 130. It may be also understood that any network node is an example of the first network node 111, and that any description provided for any network node 910 or for the network node 1104 equally applies to the first network node 111. It may further be understood that the communication system 900 is an example of the wireless communication network 100, and that any description provided for the communication system 900 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless device 130, exemplified in FIG. 9 as the UEs 912, may be any of a wide variety of communication devices, including wireless devices arranged, configured, and/or operable to communicate wirelessly with the first network node 111, exemplified in FIG. 9 as network nodes 910, and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes, e.g., core network node 908, that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, New Radio (NR) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs, e.g., UE 912c and/or 912d, and network nodes, e.g., network node 910b. In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

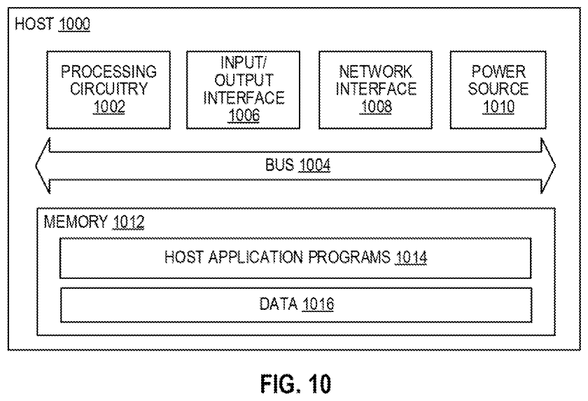

FIG. 10 is a block diagram of a host 1000, which may be an embodiment of the host 916 of FIG. 9, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 shows a communication diagram of a host 1102 communicating via a network node 1104 with a UE 1106 over a partially wireless connection in accordance with some embodiments. Example implementations, in accordance with various embodiments, of the UE, such as a UE 912a of Figure QQ, network node, such as network node 910a of FIG. 9, and host, such as host 916 of FIG. 9 and/or host 1000 of FIG. 10, discussed in the preceding paragraphs will now be described with reference to FIG. 11.

Like host 1000, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 906 of FIG. 9) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion, e.g., controlling traffic lights. As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors, not shown, may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

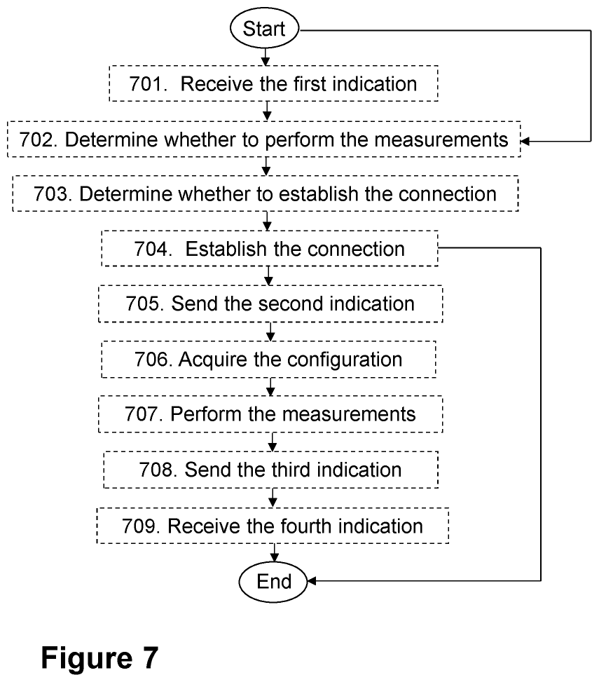

The wireless device 130 embodiments relate to FIG. 3, FIG. 5, FIG. 7, FIG. 9 and FIG. 11.

The wireless device 130 may also be configured to communicate user data with a host application unit in a host 916, 1000, 1102, e.g., via an OTT connection such as OTT connection 1150.

The wireless device 130 may comprise an interface unit to facilitate communications between the wireless device 130 and other nodes or devices, e.g., the first network node 111, the host 916, 1000, 1102, or any of the other nodes. In some particular examples, the interface may, for example, include a transceiver configured to transmit and receive radio signals over an air interface in accordance with a suitable standard.

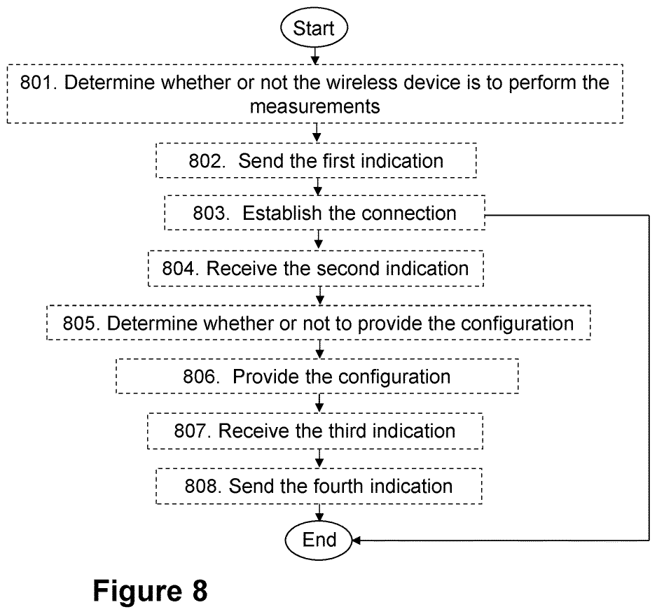

The first network node 111 embodiments relate to FIG. 4, FIG. 6, FIG. 8, FIG. 9 and FIG. 11.

The first network node 111 may also be configured to communicate user data with a host application unit in a host 916, 1000, 1102, e.g., via a connection 1160.

The first network node 111 may comprise an interface unit to facilitate communications between the first network node 111 and other nodes or devices, e.g., the wireless device 130, the host 916, 1000, 1102, or any of the other nodes. In some particular examples, the interface may, for example, include a transceiver configured to transmit and receive radio signals over an air interface in accordance with a suitable standard.

### FURTHER NUMBERED EMBODIMENTS

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the first network node 111.
2. The host of the previous embodiment, wherein:
the processing circuitry of the host is configured to execute a host application that provides the user data; and
the UE comprises processing circuitry configured to execute a client application associated with the host application to receive the transmission of user data from the host.
3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the first network node 111.
4. The method of the previous embodiment, further comprising, at the network node, transmitting the user data provided by the host for the UE.
5. The method of any of the previous 2 embodiments, wherein the user data is provided at the host by executing a host application that interacts with a client application executing on the UE, the client application being associated with the host application.
6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the first network node 111.
7. The communication system of the previous embodiment, further comprising:
the network node; and/or
the user equipment.
8. The communication system of the previous 2 embodiments, wherein:
the processing circuitry of the host is configured to execute a host application, thereby providing the user data; and
the host application is configured to interact with a client application executing on the UE, the client application being associated with the host application.
9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the first network node 111.
10. The host of the previous 2 embodiments, wherein:
the processing circuitry of the host is configured to execute a host application, thereby providing the user data; and
the host application is configured to interact with a client application executing on the UE, the client application being associated with the host application.
11. The host of the any of the previous 2 embodiments, wherein the initiating receipt of the user data comprises requesting the user data.
12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the first network node 111.
13. The method of the previous embodiment, further comprising at the network node, transmitting the received user data to the host.
14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.
15. The host of the previous embodiment, wherein the cellular network further includes a network node configured to communicate with the UE to transmit the user data to the UE from the host.
16. The host of the previous 2 embodiments, wherein:
the processing circuitry of the host is configured to execute a host application, thereby providing the user data; and
the host application is configured to interact with a client application executing on the UE, the client application being associated with the host application.
17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.
18. The method of the previous embodiment, further comprising:
at the host, executing a host application associated with a client application executing on the UE to receive the user data from the UE.
19. The method of the previous embodiment, further comprising:
at the host, transmitting input data to the client application executing on the UE, the input data being provided by executing the host application,
wherein the user data is provided by the client application in response to the input data from the host application.
20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.
21. The host of the previous embodiment, wherein the cellular network further includes a network node configured to communicate with the UE to transmit the user data from the UE to the host.
22. The host of the previous 2 embodiments, wherein:
the processing circuitry of the host is configured to execute a host application, thereby providing the user data; and
the host application is configured to interact with a client application executing on the UE, the client application being associated with the host application.
23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.
24. The method of the previous embodiment, further comprising:
at the host, executing a host application associated with a client application executing on the UE to receive the user data from the UE.
25. The method of the previous embodiments, further comprising:
at the host, transmitting input data to the client application executing on the UE, the input data being provided by executing the host application,
wherein the user data is provided by the client application in response to the input data from the host application.

1.-42. (canceled)

43. A method performed by a wireless device, the method being for handling a configuration, the wireless device operating in a wireless communications network, the method comprising:
determining, while the wireless device lacks an active connection with any network node operating in the wireless communications network, whether or not the wireless device is to perform one or more measurements for broadcast or multicast traffic;
determining, based on a first result of the determination, whether or not to establish a connection with a first network node operating in the wireless communications network to receive the configuration, wherein the configuration is to perform the one or more measurements; and
establishing the connection with the first network node based on a second result of the determination of whether or not to establish the connection.

44. The method according to claim 43, wherein the one or more measurements are one or more quality of experience measurements.

45. The method according to claim 43, further comprising at least one of:
receiving a first indication from the first network node, the first indication indicating whether or not the wireless device is to perform the one or more measurements, and wherein the determining of whether or not the wireless device is to perform one or more measurements is based on the received first indication; and
sending a second indication to the first network node, the second indication indicating that the configuration is requested.

46. The method according to claim 45, wherein at least one of:
the first indication is received, and the first indication further indicates whether or not the wireless device is to perform the one or more measurements, per type of traffic;
the first indication is received, and the first indication is received in a broadcast message;
the first indication is received, and the first indication explicitly indicates the configuration is to be fetched for a broadcast reception; and
the second indication is sent and the second indication indicates, explicitly or implicitly, which type of broadcast or multicast traffic the one or more measurements are to be performed on.

47. The method according to claim 43, wherein the determining of whether or not to establish the connection with the first network node is based on at least one of:
whether or not the wireless device intends to receive the broadcast or multicast traffic,
whether or not the wireless device determines that the broadcast or multicast traffic has already started,
whether or not the wireless device has a first capability to receive broadcast receptions, and
whether or not the wireless device has a second capability to perform the one or more measurements.

48. The method according to claim 43, wherein the determining of whether or not the wireless device is to perform the one or more measurements is responsive to the wireless device having determined, while the wireless device lacks the active connection with any network node, that the wireless device desires to receive at least one of broadcast and multicast traffic.

49. The method according to claim 48, wherein the determining of whether or not to establish the connection with the first network node further comprises determining whether or not the wireless device has a valid configuration to perform the one or more measurements.

50. The method according to claim 49, wherein the establishing is performed with the proviso that the wireless device has determined the wireless device lacks the valid configuration.

51. The method according to claim 43, further comprising at least one of:
acquiring the configuration from the first network node after establishing the connection;
performing the one or more measurements according to the configuration;
sending a third indication indicating the performed one or more measurements according to the configuration; and
receiving, after having performed the one or more measurements according to the configuration, a fourth indication from the first network node, the fourth indication indicating whether or not the wireless device is to return to a mode wherein the wireless device lacks a connection with any network node operating in the wireless communications network.

52. A method performed by a first network node, the method being for handling a configuration of a wireless device, the first network node operating in a wireless communications network, the method comprising:
determining, while the first network node lacks an active connection with the wireless device operating in the wireless communications network, whether or not the wireless device is to perform one or more measurements for broadcast or multicast traffic,
sending, based on a result of the determination, a first indication to the wireless device, the first indication indicating whether or not the wireless device is to perform the one or more measurements, and
establishing a connection with the wireless device based on the result of the determination, and after having sent the first indication, and wherein, with the proviso the first network node establishes the connection, the first network node is enabled to provide the configuration to perform the one or more measurements.

53. The method according to claim 52, wherein at least one of:
the one or more measurements are quality of experience measurements;
the first indication further indicates whether or not the wireless device is to perform the one or more measurements, per type of traffic;
the first indication is sent in a broadcast message; or
the first indication explicitly indicates the configuration is to be fetched for a broadcast reception.

54. The method according to claim 52, further comprising receiving a second indication from the wireless device, the second indication indicating that the configuration is requested.

55. The method according to claim 54, wherein the second indication indicates, explicitly or implicitly, which type of broadcast or multicast traffic the one or more measurements are to be performed on.

56. The method according to claim 52, wherein the determining of whether or not the wireless device is to perform one or more measurements for broadcast or multicast traffic is based on at least one of:
whether or not the wireless device intends to receive the broadcast or multicast traffic,
whether or not the wireless device determines that the broadcast or multicast traffic has already started,
whether or not the wireless device has a first capability to receive broadcast receptions, and
whether or not the wireless device has a second capability to perform the one or more measurements.

57. The method according to claim 52, wherein the determining of whether or not the wireless device is to perform the one or more measurements is responsive to the wireless device having determined, while the wireless device lacks the active connection with any network node, that it desires to receive at least one of broadcast and multicast traffic, and wherein the determining of whether or not to establish the connection with the wireless device further comprises determining whether or not the wireless device has a valid configuration to perform the one or more measurements, and wherein the establishing is performed with the proviso that the wireless device lacks the valid configuration.

58. The method according to claim 52, further comprising at least one of:
determining whether or not to provide the configuration to the wireless device;
providing the configuration to the wireless device after establishing the connection, based on a result of the determining of whether or not to provide the configuration to the wireless device;
receiving a third indication from the wireless device, the third indication indicating the one or more measurements performed by the wireless device according to the configuration; and
sending, after having received the third indication from the wireless device, the third indication indicating that the wireless device has performed the one or more measurements according to the configuration, a fourth indication to the wireless device, the fourth indication indicating whether or not the wireless device is to return to a mode wherein the wireless device lacks a connection with any network node operating in the wireless communications network.

59. The method according to claim 58, wherein the fourth indication indicates the wireless device is to return to one of IDLE and INACTIVE state.

60. The method according to claim 52, wherein at least one of:
the wireless device lacking the active connection with any network node is in one of IDLE and INACTIVE mode;
the establishing is performed with the proviso that the wireless device has a first capability to receive broadcast reception;
the determining is based on whether or not the wireless device has a second capability to perform the one or more measurements;
the establishing is performed with the proviso the wireless device has a second capability to perform the one or more measurements;
the providing of the configuration is in one of: a broadcast channel, a dedicated channel and a unicast channel;
the providing of the configuration is in one of: a broadcast channel, a dedicated channel and a unicast channel, based on a state of the wireless device;
the broadcast channel is one of Multicast Broadcast Control Channel (MCCH) and Multicast Broadcast Transmission Channel (MTCH); and
the providing of the configuration is in dedicated Radio Resource Control signalling.

61. A wireless device, for handling a configuration, the wireless device being configured to operate in a wireless communications network, the wireless device comprising:
radio circuitry; and
processing circuitry configured to:
determine, while the wireless device lacks an active connection with any network node configured to operate in the wireless communications network, whether or not the wireless device is to perform one or more measurements for broadcast or multicast traffic;
determine, based on a first result of the determination, whether or not to establish a connection with a first network node configured to operate in the wireless communications network to receive the configuration, wherein the configuration is configured to be to perform the one or more measurements; and
establish the connection with the first network node based on a second result of the determination of whether or not to establish the connection.

62. A first network node, for handling a configuration of a wireless device, the first network node being configured to operate in a wireless communications network, the first network node comprising:
radio circuitry; and
processing circuitry configured to:
determine, while the first network node lacks an active connection with the wireless device configured to operate in the wireless communications network, whether or not the wireless device is to perform one or more measurements for broadcast or multicast traffic;
send, based on a result of the determination, a first indication to the wireless device, the first indication being configured to indicate whether or not the wireless device is to perform the one or more measurements; and
establish a connection with the wireless device based on the result of the determination, and after having sent the first indication, and wherein, with the proviso the first network node establishes the connection, the first network node is configured to be enabled to provide the configuration to perform the one or more measurements.
